(19) United States
(12) Patent Application Publication
(10) Pub. No.: US 2025/0111304 A1
(43) Pub. Date: Apr. 3, 2025

(54) DYNAMIC DATA DELIVERABLE TOOL

(71) Applicant: Rolls-Royce Corporation, Indianapolis, IN (US)

(72) Inventors: Stephen Hollander, Indianapolis, IN (US); Daniel Kubler, Indianapolis, IN (US); William Belcher, Indianapolis, IN (US)

(21) Appl. No.: 18/899,827

(22) Filed: Sep. 27, 2024

Related U.S. Application Data
(60) Provisional application No. 63/541,605, filed on Sep. 29, 2023.

(51) Int. Cl. G06Q 10/0631

(52) U.S. Cl. CPC G06Q 10/063114

(57) ABSTRACT

Computer implementations for managing contract data requirements list (CDRL) deliverables are disclosed. In some implementations, a controller identifies a CDRL deliverable associated with a program. The controller determines whether the CDRL deliverable is associated with a milestone of a plurality of milestones associated with the program and whether the CDRL is associated with a recurrence. In addition, the controller determines a delivery date for the CDRL deliverable based on whether the CDRL is associated with the milestone and whether the CDRL deliverable is associated with the recurrence. The controller displays, via a display, a CDRL deliverable name of the CDRL deliverable and at least one of: the delivery date, a delivery status corresponding to the delivery date, and a delivery evaluation corresponding to the delivery date.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/541,605 filed on Sep. 29, 2023, the entire disclosure of which is hereby expressly incorporated herein by reference.

### TECHNICAL FIELD

This disclosure relates to software tracking for electronic deliverables transmitted to computing devices.

### BACKGROUND

When a United States governmental agency awards a contract to a contractor, the contractor may be under an obligation pursuant to the contract to provide certain deliverables at various times to the governmental agency. Particularly for contracts that are relatively long in duration (e.g., years or decades) and/or where the amount of work required under the contract is relatively large (e.g., in terms of manpower and/or monetary value), the number of deliverables due to the governmental agency is extremely large and difficult to manage manually. This is especially the case when a change in one date requires a change to tens, hundreds, or thousands of other dates. Moreover, due to the large number of deliverables each having their own deadlines, it is extremely difficult from a project management standpoint to identify the statuses of the deliverables at any given point in time, and in turn to provide optimal management and distribution of resources toward the various ongoing deliverables. Ways to leverage computing technology to provide a technological solution to these difficulties may be desirable.

### SUMMARY

The present disclosure may comprise one or more of the following features and combinations thereof.

According to a first aspect of the present disclosure, a method includes identifying, with a controller, a contract data requirements list (CDRL) deliverable associated with a program. The method includes determining, with the controller, whether the CDRL deliverable is associated with a milestone of a plurality of milestones associated with the program and whether the CDRL is associated with a recurrence.

In some embodiments, the method further includes determining, with the controller, a delivery date for the CDRL deliverable based on whether the CDRL is associated with the milestone and whether the CDRL deliverable is associated with the recurrence. The method further includes displaying, with the controller via a display, a CDRL deliverable name of the CDRL deliverable and at least one of: the delivery date, a delivery status corresponding to the delivery date, and a delivery evaluation corresponding to the delivery date.

In some embodiments, the method further includes, in response to determining that the CDRL deliverable is not associated with any milestone of the plurality of milestones and is not associated with any recurrence of the one or more recurrences, determining the delivery date for the CDRL deliverable comprises determining the delivery date to be an input delivery date.

In some embodiments, the method further includes, in response to determining that the CDRL deliverable is not associated with any milestone of the plurality of milestones and is associated with the recurrence, determining the delivery date for the CDRL deliverable comprises determining the delivery date according to a start date and a day-of-month for recurrence value.

In some embodiments, the method further includes, in response to determining that the CDRL deliverable is associated with the milestone and is not associated with any recurrence, determining the delivery date for the CDRL deliverable comprises determining the delivery date according to a milestone date of the milestone and a date calculation rule associated with the CDRL deliverable.

In some embodiments, the CDRL deliverable comprises a first CDRL deliverable, the milestone comprises a first milestone, and the delivery date comprises a first delivery date. The method further includes, in response to determining that the first CDRL deliverable is associated with the first milestone of the plurality of milestones and is associated with the recurrence, determining the first delivery date for the first CDRL comprises determining the first delivery date according to a first milestone date associated with the first milestone and a date calculation rule associated with the recurrence.

In some embodiments, the method further includes determining a second delivery date for a second CDRL deliverable associated with the recurrence according to a second milestone date associated with a second milestone and the date calculation rule associated with the recurrence.

In some embodiments, the method further includes detecting, with the controller, an update to a milestone date of the milestone; in response to detecting the update; determining, with the controller, that the CDRL deliverable is associated with the milestone; and, in response to determining that the CDRL deliverable is associated with the milestone, updating, with the controller, the delivery date for the CDRL deliverable according to the update to the milestone date.

In some embodiments, the method further includes, in response to detecting the update to the milestone date, identifying, with the controller, a set of CDRL deliverables associated with the milestone in a CDRL database by identifying which of a plurality of CDRL deliverables in the CDRL database are associated with a milestone ID of the milestone; and updating, with the controller, delivery dates for all of the CDRL deliverables associated with the milestone according to the change to the milestone date.

In some embodiments, the further method includes querying, with the controller, a milestone database with a milestone identification (ID) of the milestone, the milestone database associating at least one milestone ID with at least one milestone date; and in response to the querying, determining, with the controller, a milestone date associated with the milestone ID. Determining the delivery date includes determining the delivery date according to the milestone date.

In some embodiments, the method further includes displaying, with the controller via a user interface, a CDRL deliverable list indicating a plurality of CDRL deliverable names and at least one of: a plurality of delivery dates each associated with a respective one of the plurality of CDRL deliverables, a plurality of delivery statuses each associated with the respective one of the plurality of CDRLs, and a plurality of delivery evaluations each associated with the respective one of the plurality of CDRL deliverables.

In some embodiments, the CDRL deliverable list further indicates one or more CDRL group identifications (IDs) with which each of the plurality of CDRL deliverables is associated.

In some embodiments, the CDRL deliverable list further indicates one or more owners with which each of the plurality of CDRL deliverables is associated.

In some embodiments, the method further includes displaying, with the controller via the user interface, at least one add CDRL user interface (UI) element adjacent to the CDRL deliverable list, the at least one add CDRL UI element, upon being triggered, configured to cause display of at least one add CDRL interface for addition of a new CDRL deliverable or a new CDRL recurrence to the CDRL deliverable list.

In some embodiments, the at least one add CDRL UI element comprises an add CDRL deliverable UI element and an add CDRL recurrence UI element, and wherein the at least one add CDRL interface comprises an add CDRL deliverable interface and an add CDRL recurrence interface.

In some embodiments, the method further includes displaying the add CDRL deliverable interface in response to triggering the add CDRL deliverable UI element; and displaying the add CDRL recurrence interface in response to triggering the add CDRL recurrence UI element.

In some embodiments, the method further includes automatically updating, with the controller, the CDRL deliverable list with the new CDRL deliverable or the new CDRL recurrence in response to submission of information corresponding to the new CDRL deliverable or the new CDRL recurrence using the at least one add CDRL interface.

In some embodiments, the at least one add CDRL interface comprises a checkbox to link the new CDRL deliverable or the new CDRL recurrence to the milestone.

In some embodiments, the method further includes accessing, with the controller, a CDRL database comprising a database entry for the CDRL deliverable, wherein the database entry comprises CDRL deliverable identification (ID) field, a milestone ID field, and a recurrence ID field.

In some embodiments, the database entry further comprises at least one of a deliverable content link field and a comments field.

In some embodiments, the method further includes displaying, with the controller via a user interface, a near term view comprising a plurality of areas each associated with a respective one of a plurality of date ranges; and displaying, with the controller via the user interface, a plurality of CDRL deliverable names of a plurality of CDRL deliverables and a plurality of associated delivery statuses or a plurality of delivery evaluations in the plurality of areas according to respective delivery dates of the plurality of CDRL deliverables and the plurality of date ranges of the plurality of areas.

In some embodiments, the method further includes displaying, with the controller via the user interface, a cumulative view comprising a plurality of curves, each curve comprising a cumulative number of CDRL deliverables as a function of time, wherein the plurality of curves is associated with at least two of: a submitted delivery status, a rework category, a questions category; a completed delivery status; a behind delivery evaluation; or an on track delivery evaluation.

In some embodiments, the method further includes switching, with the controller via the interface, between the near term view and the cumulative view in response to an input to a program view input box displayed in the user interface.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a block diagram of a system configured to manage contract data requirements list (CDRL) deliverables associated with a program.

FIG. 2 illustrates a schematic diagram of example CDRL deliverable data.

FIG. 3 illustrates a schematic diagram of an example CDRL deliverable list configured in a CDRL management interface.

FIG. 4 illustrates a schematic diagram of an example add CDRL deliverable interface configured in a CDRL management interface.

FIG. 5 illustrates a schematic diagram of an example add CDRL recurrence interface configured in a CDRL management interface.

FIG. 6 illustrates a schematic diagram of a near term program view of CDRL deliverables configured in a CDRL management interface.

FIG. 7 illustrates a schematic diagram of a cumulative program view of CDRL deliverables configured in a CDRL management interface.

FIG. 8 illustrates a schematic diagram of a CDRL deliverable expanded information interface.

FIG. 9 illustrates a flow chart of an example method of determining delivery dates for CDRL deliverables.

FIG. 10 illustrates a flow chart of another example method of determining delivery dates for CDRL deliverables.

FIG. 11 illustrates a flow chart of an example method of adjusting delivery dates for CDRL deliverables in response to a change to a milestone date.

FIG. 12 illustrates a diagram of an example computer system.

### DETAILED DESCRIPTION

The following describes computer-implemented systems, apparatus, devices, and related methods of contract data requirements list (CDRL) deliverable management. In general, a first entity, referred to herein as a contractor, may perform certain actions for a second entity, referred to herein as a customer. An example customer is a governmental agency, although types of customers other than a governmental agency may be possible. The actions that the contractor may perform may be or specified under a program. For example, a governmental agency may award a program to the contractor, according to which the contractor may agree to perform the actions as specified under the program.

Some of these actions may include delivery of contract data requirements list (CDRL) deliverables. As used herein, a CDRL deliverable is electronic content that is electronically transmitted from the contractor to the customer in a single transmission instance. The electronic content may include any form of electronic media. Most commonly, at least a part of the electronic content is in the form of an electronic document, such as in the form of a report, a chart, a schedule, a plan, a presentation, or other similar format, that indicates information viewable by way of a computing device that processes and reads the electronic content and displays the electronic content on a computer screen or by converting the electronic content to a viewable physical medium, such as paper. Additionally, a CDRL deliverable can be electronically transmitted using computing technology. For example, a first computer on the contractor side may electronically transmit the CDRL deliverable to a second computer on the customer side, such as over a network connection. Also, each CDRL deliverable may have an associated delivery date, which may include a day on which the CDRL deliverable is to be transmitted, or otherwise stated, the day on which the single transmission instance is to occur.

Under any of various programs, one or more CDRL deliverables may be defined at the start of the program. For example, a Statement of Work (SoW) may be established at the start of the program, and may define one or more CDRL deliverables. Other CDRL deliverables are established after the start of the program, including days, months, or years after the start of the program. In this way, the composition of CDRL deliverables, including the types of CDRL deliverables, the number of CDRL deliverables, and the delivery dates for the CDRL deliverables, for a customer over the course of the program is always changing.

Also, some CDRL deliverables may not go into effect unless some condition or event associated with other CDRL deliverables occurs. For example, a CDRL deliverable that includes an update of an original CDRL deliverable may not go into effect unless the customer specifies that an update is required.

In addition to CDRL deliverables, a given program may define or include one or more milestones. A milestone is generally a significant event, such as a design review as a non-limiting example. The date on which a milestone occurs is referred to as a milestone date. Some milestones may be defined at the start of a program, such as by being defined in the Statement of Work (SoW) of the program. Additionally, some milestones defined at the start of the program may be in effect, while others may not be in effect. By being in effect, a milestone, or the event related to the milestone, is to occur. Some of these milestones that are considered “in effect” at the start of the program may have milestone dates that are set. Other of these milestones may be “in effect”, but their milestone dates are not yet set. Such other milestone will occur, but the customer and/or the contractor have not yet determined or finalized a milestone date for the milestone. Still other milestones be known or defined but may not be in effect at the start of the program. For example, certain parameters defining a milestone may be known or specified at the start of the program, but the customer and contractor do not know whether the milestone will occur. In some instances, whether the milestone goes into effect may depend or be conditioned on the occurrence of another event, and whether that other event occurs may only be known after the program is underway. To illustrate, a certain milestone may be related to a cyberattack. The parameters associated with the certain milestone may be defined under the program. However, whether the certain milestone goes into effect may depend on whether the cyberattack actually occurs. Other milestones, including their associated parameters and dates, may be completely unknown at the start of the program, and may be created or established only after the program has started.

Additionally, at least some CDRL deliverables may be delivered or completed only if a milestone is in effect. That is, a given milestone may have an associated set of one or more CDRL deliverables. Whether the associated set of deliverables are in effect (i.e., are to be delivered) may depend on whether the given milestone is in effect. That is, the given milestone going into effect triggers the associated set of deliverables to be in effect as well. Conversely, if the given milestone is not in effect, then the associated set of CDRL deliverables are also not in effect.

Also, some CDRL deliverables may have delivery dates that are determined or set relative to milestone dates. For example, a delivery date of a CDRL deliverable may be a certain X number of days before or after a milestone date of a given milestone. Other delivery dates of CDRL deliverables may not be tied to milestone dates. For example, a CDRL deliverable may be due on a certain date not relative to any milestone date.

In addition, some CDRL deliverables may be part of a CDRL recurrence. In general, a CDRL recurrence is a set of CDRL deliverables with delivery dates determined from a same delivery date calculation rule. Some CDRL recurrences may be associated with a set of milestones. Other CDRL recurrences may not be associated with any milestones. For a CDRL recurrence that is associated with a set of milestones, the delivery date calculation rule may define or set forth a certain number of days before or after a given milestone date by which an associated CDRL deliverable of the CDRL occurrence is to be delivered. Each CDRL deliverable that is part of a CDRL recurrence may be associated with a respective milestone of the set of milestones, and may have a delivery date that is the certain number of days before or after a milestone date of the associated milestone. Additionally, for a CDRL recurrence that is not associated with any milestone, the delivery date calculation rule may include information used to determine a delivery date for each CDRL deliverable of the CDRL recurrence. For example, the same delivery date calculation rule for a CDRL recurrence that is not associated with a milestone may include the same start date of the CDRL recurrence, the same end date of the CDRL recurrence, and the same day-of-month on which each CDRL deliverable of the CDRL recurrence is to be delivered.

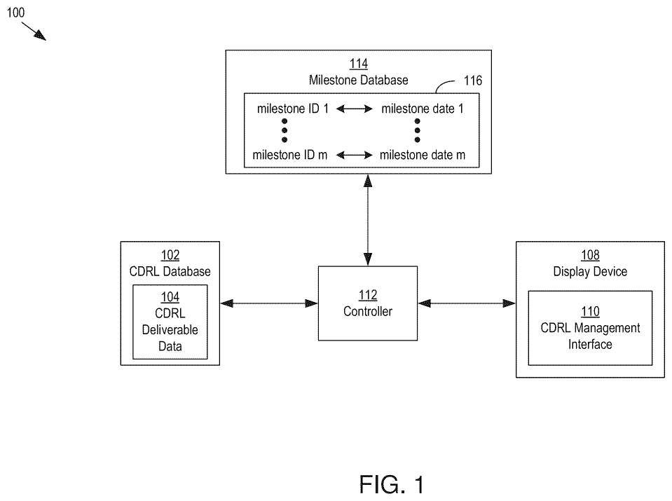

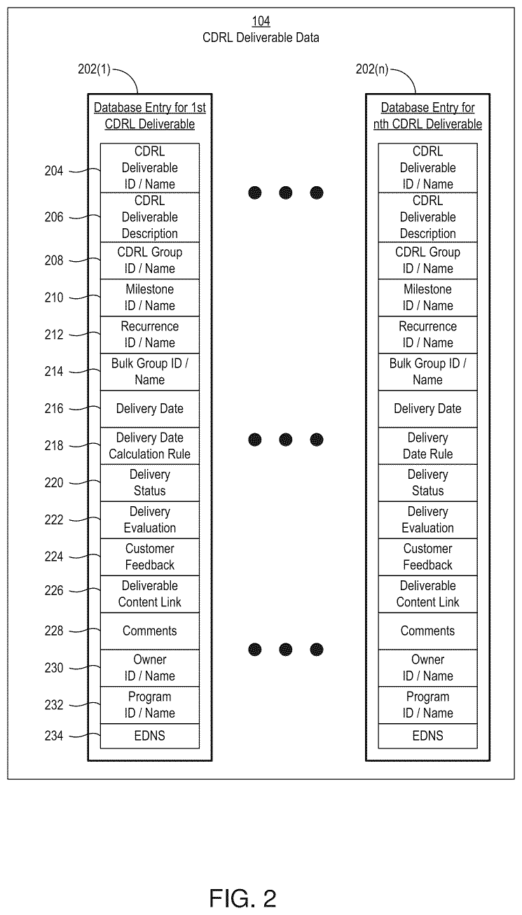

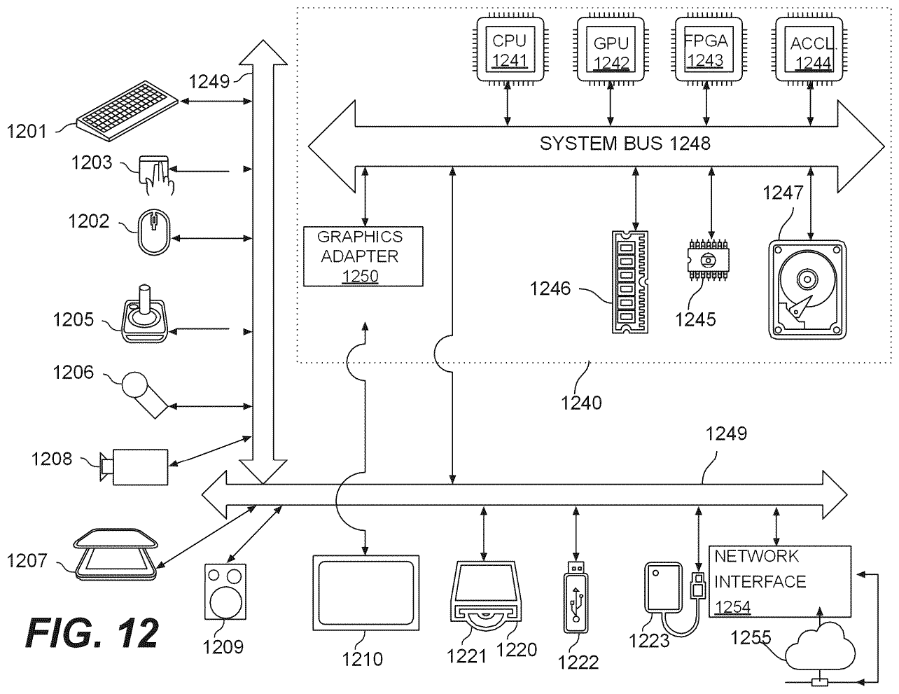

FIG. 1 illustrates an example system 100 configured to manage contract data requirements list (CDRL) deliverables. The system 100 may include a CDRL database 102 including CDRL deliverable data 104. The CDRL deliverable data 104 may include data and/or information describing, defining, characterizing, and/or otherwise associated with one or more CDRL deliverables. Further details of the CDRL deliverable data 104 is described in further detail below with respect to FIG. 2. Additionally, the CDRL database 102 and/or the CDRL deliverable data 104 may be stored in memory, such as volatile memory, non-volatile memory, or combinations thereof. Example types of memory in which the CDRL database 102 and/or the CDRL deliverable data 104 is stored is described in further detail below with respect to the computer system 1200 of FIG. 12.

The system 100 may further include a display device 108 configured to display a CDRL management interface 110. The display device 108 may include a computer monitor, a television screen, or other similar display device as described in further detail below with respect to the computer system 1200 of FIG. 12. The CDRL management interface 110 includes a graphical user interface (GUI) that allows a user viewing the display to visually identify information about CDRL deliverables. The information about the CDRL deliverables may be or otherwise derived from the CDRL deliverable data 104, as described in further detail below. A user may also be able to input information about CDRL deliverables into the CDRL management interface 110, or otherwise be able to input the information into the system 100 via the CDRL management interface 110 so that the information can be accessed, processed, displayed, and/or used by one or more components of the system 100, as described in further detail below.

Additionally, the system 100 may include a controller 112 configured to communicate with each of the CDRL database 102 and the display device 108. The controller 112 may access the CDRL database 102, and read the CDRL deliverable data from the CDRL database 102. In addition, the CDRL controller 112 may be configured to cause the CDRL management interface 110 to be displayed on the display device 108, and control which data, including which CDRL deliverable data 104, is displayed in the CDRL management interface 110 at any given point in time. Additionally, when CDRL information is input into the CDRL management interface 110, the controller 112 may identify the input CDRL information, and store or write the input CDRL information to the CDRL database 102. Further functionality of the controller 112, including determination or calculation of delivery dates of the CDRL deliverables, is described in further detail below. Also, in any of various implementations, the controller 112 may include circuitry configured in hardware, or a combination of hardware and software. Example configurations of the controller 112 is described in further detail below with respect to the computer system 1200 of FIG. 12.

Additionally, for at least some implementations, the system 100 may include, or otherwise be coupled to, a milestone database 114 that includes or indicates information about one or more milestones. For at least some of these implementations, the milestone database 114 includes one more milestone associations 116 that each associate a milestone identification (ID) of a given milestone with a respective milestone date on which the given milestone is to occur. FIG. 1 shows the milestone database 114 including an m-number of milestone associations 116, including a first milestone ID 1 associated with a first milestone date 1, and extending to an mth milestone ID associated with an mth milestone date m. At any of various times during operation, the milestone database 114 may not include any milestone associations 116, only one milestone association 116, or multiple milestone associations 116. The controller 112 may be configured to access the milestone database 114, and upon doing so, may identify the milestone associations 116. For example, the controller 112 may query the milestone database 114 with a given milestone ID, locate the given milestone ID in the milestone database 114, and in turn identify the milestone data 116 associated with the given milestone ID. In addition or alternatively, upon accessing the milestone database 114, the controller 112 may be configured to update or modify milestone associations 116 at any of various points in time during operation. For example, the controller 112 may add a new or additional association of a new milestone ID and a new milestone date. In addition or alternatively, the controller 112 may modify an existing milestone association 116. For example, the controller 112 may be configured to detect that a milestone date associated with a given milestone has changed. In turn, the controller 112 may identify the milestone ID for the given milestone in the milestone database 114, and correspondingly change the associated milestone date according to the detected change to the milestone date. Milestones and their associated milestone IDs and milestone dates are described in further detail below. Additionally, the milestone database 114 may be stored in memory, such as volatile memory, non-volatile memory, or combinations thereof. Example types of memory in which the milestone database 114 is stored is described in further detail below with respect to the computer system 1200 of FIG. 12.

FIG. 2 shows a schematic diagram of types of data forming CDRL deliverable data 104 associated with one or more CDRL deliverables. As shown in FIG. 2, the CDRL deliverable data 104 may be include one or more database entries 202, each associated with a respective CDRL deliverable. That is, the CDRL data or information that is part of the same database entry 202 is, in turn, associated with the same CDRL deliverable. Correspondingly, FIG. 2 shows a first database entry 202(1) for a first CDRL deliverable, and extending to an nth database entry 202 (n) for an nth CDRL deliverable. During implementation, at any given point in time, the CDRL deliverable data 104 may not include any CDRL deliverable entries 202, only one CDRL deliverable entry, or two or more CDRL deliverable entries 202, depending on the number of CDRL deliverables input into or otherwise recognized by the system 100.

As shown in FIG. 2, each CDRL deliverable entry 202 may a plurality of fields 204-234. Each field may be empty or be populated with a particular value indicating particular information for that field, which may be identified and used by the controller 112.

In further detail, each CDRL deliverable entry 202 may include a CDRL deliverable identification (ID) and/or a CDRL deliverable name field 204. The CDRL deliverable ID of a given CDRL deliverable may be an alphanumeric value that uniquely identifies the given CDRL deliverable in the system 100, or at least among CDRL deliverables associated with or under a given or the same program or contract. The CDRL deliverable name of a given CDRL deliverable may be a word or phrase that identifies or characterizes the given CDRL deliverable. In any of various implementations, the CDRL deliverable name may or may not be a unique name in the system 100 or among CDRL deliverable names under a given or the same program or contract. In addition or alternatively, for at least some implementations, each CDRL deliverable name of a given CDRL deliverable may be in accordance with a certain, predetermined CDRL nomenclature used to identify or characterize the CDRL deliverable and/or indicate a type of the given CDRL deliverable. For example, a given CDRL deliverable name may be “Monthly Status Report” or “Technical Report 7”, as non-limiting examples. In the latter example, the part of the name “Technical Report” indicates the type of the CDRL deliverable, and the number 7 is used to distinguish that CDRL deliverable from other CDRL deliverables also having “Technical Report” in their names. In any of various implementations, a given CDRL deliverable entry 202 may include only a CDRL deliverable ID, only a CDRL deliverable name, or both a CDRL deliverable ID and a CDRL deliverable name. Also, for simplicity, the CDRL deliverable ID and CDRL deliverable name are shown as being part of the same field 204. However, in any of various other implementations, the CDRL deliverable ID and the CDRL deliverable name may be separate pieces of data or information, included in separate fields, separately accessed by the controller 112, and/or separately displayed in the CDRL management interface 110.

In addition, for at least some implementations, each CDRL deliverable entry 202 may include a CDRL deliverable description field 206, which may include a string of characters or words providing description or context for an associated CDRL deliverable. For example, a CDRL deliverable in the form of a recurring program status report may include a brief description of the recurring report, its purpose, and an indication of the recurring submittal due date.

In addition, for at least some implementations, each CDRL deliverable entry 202 may include a CDRL group (or item) ID and/or a CDRL group name field 208. In general, two or more CDRL deliverables may be part of a same CDRL group. For example, a first CDRL deliverable of a given CDRL group may be an initial submission that includes an initial version of a report or other document, and a second CDRL deliverable of the same, given CDRL group may be subsequent submission that includes a revised or updated version of the report or other document. Similar to the CDRL deliverable ID, a CDRL group ID may be an alphanumeric value that uniquely identifies a CDRL group in the system 100 or at least among various CDRL groups under a same program or contract. The CDRL group name of a given CDRL group may be a word or phrase that identifies or characterizes the given CDRL group. In any of various implementations, the CDRL group name may or may not be a unique name in the system 100 or among CDRL group names under a given or the same program or contract. In addition or alternatively, for at least some implementations, each CDRL group name of a given CDRL group may be in accordance with a certain, predetermined CDRL nomenclature used to identify or characterize the CDRL group and/or indicate a type of the given CDRL group. In addition or alternatively, in any of various implementations, a given CDRL deliverable group 208 may include only a CDRL group ID, only a CDRL group name, or both a CDRL group ID and a CDRL group name. Also, for simplicity, the CDRL group ID and CDRL group name are shown as being part of the same field 208. However, in any of various other implementations, the CDRL group ID and the CDRL group name may be separate pieces of data or information, included in separate fields, separately accessed and/or processed by the controller 112, and/or separately displayed in the CDRL management interface 110.

In addition, for at least some implementations, each CDRL deliverable entry 202 may include a milestone ID and/or a milestone name field 210. Similar to the CDRL deliverable ID, a milestone ID may be an alphanumeric value that uniquely identifies a milestone in the system 100 or at least among various milestones under a same program or contract. The milestone name of a given milestone may be a word or phrase that identifies or characterizes the given milestone. In any of various implementations, the milestone name may or may not be a unique name in the system 100 or among milestone names under a given or the same program or contract. In addition or alternatively, for at least some implementations, each milestone name of a given milestone may be in accordance with a certain, predetermined milestone nomenclature used to identify or characterize the milestone and/or indicate a type of the given milestone. Non-limiting examples of a milestone name may include “contract award”, “Preliminary Design Review” or PDR, “System Requirements Review” or SRR, and “Critical Design Review” or CDR. In addition or alternatively, in any of various implementations, a given milestone ID/name field 210 may include only a milestone ID, only a milestone name, or both a milestone ID and a milestone name. Also, for simplicity, the milestone ID and milestone name are shown as being part of the same field 210. However, in any of various other implementations, the milestone ID and the milestone name may be separate pieces of data or information, included in separate fields, separately accessed and/or processed by the controller 112, and/or separately displayed in the CDRL management interface 110.

Also, in event that a given CDRL deliverable is not associated with, or connected to, a milestone, the milestone ID/name field 210 may be blank or empty, or may otherwise be populated with a default value, such as a value corresponding to logic ‘0’, which in turn may indicate to the controller 112 that the given CDRL deliverable is not associated with, or connected to, any milestone. In this way, the value in the milestone ID/name field 210 may serve as a flag that indicates to the controller 112 whether a given CDRL deliverable is associated with a milestone. In event that the milestone ID/name field 210 for a given CDRL deliverable includes a value indicating a particular milestone, then the controller 112 may determine that the given CDRL deliverable is associated with a milestone. On the other hand, in the event that the milestone ID/name field 210 for a given CDRL deliverable does not include a value indicating a particular milestone (such as by being empty or being populated with a default value), then the controller 112 may determine that the given CDRL deliverable is not associated with any milestone.

In addition, for at least some implementations, each CDRL deliverable entry 202 may include a recurrence ID and/or a recurrence name field 212. Similar to the CDRL deliverable ID, a recurrence ID may be an alphanumeric value that uniquely identifies a recurrence in the system 100 or at least among various recurrences under a same program or contract. The recurrence name of a given recurrence may be a word or phrase that identifies or characterizes the given recurrence. In any of various implementations, the recurrence name may or may not be a unique name in the system 100 or among recurrence names under a given or the same program or contract. In addition or alternatively, for at least some implementations, each recurrence name of a given recurrence may be in accordance with a certain, predetermined recurrence nomenclature used to identify or characterize the recurrence and/or indicate a type of the given recurrence. In addition or alternatively, in any of various implementations, a given recurrence ID/name field 212 may include only a recurrence ID, only a recurrence name, or both a recurrence ID and a recurrence name. Also, for simplicity, the recurrence ID and recurrence name are shown as being part of the same field 212. However, in any of various other implementations, the recurrence ID and the recurrence name may be separate pieces of data or information, included in separate fields, separately accessed and/or processed by the controller 112, and/or separately displayed in the CDRL management interface 110. Also, in event that a given CDRL deliverable is not associated with, or connected to, a recurrence, the recurrence ID/name field 212 may be blank or empty, or may otherwise be populated with a default value, such as value corresponding to logic ‘0’, which in turn may indicate to the controller 112 that the given CDRL deliverable is not associated with, or connected to, any recurrence.

Also, in event that a given CDRL deliverable is not associated with, or connected to, a recurrence, the recurrence ID/name field 212 may be blank or empty, or may otherwise be populated with a default value, such as a value corresponding to logic ‘0’, which in turn may indicate to the controller 112 that the given CDRL deliverable is not associated with, or connected to, any recurrence. In this way, the value in the recurrence ID/name field 212 may serve as a flag that indicates to the controller 112 whether a given CDRL deliverable is associated with a recurrence. In event that the recurrence ID/name field 212 for a given CDRL deliverable includes a value indicating a particular recurrence, then the controller 112 may determine that the given CDRL deliverable is associated with a recurrence. On the other hand, in event that the recurrence ID/name field 212 for a given CDRL deliverable does not include a value indicating a particular recurrence (such as by being empty or being populated with a default value), then the controller 112 may determine that the given CDRL deliverable is not associated with any recurrence.

In addition, for at least some implementations, each CDRL deliverable entry 202 may include a bulk group ID and/or a bulk group name field 214. As described in further detail below, the system 100 may be configured to perform a CDRL bulk upload process, during which information associated with at least one CDRL deliverable is uploaded or added into the system 100 for subsequent access, processing, and/or display. Of note, a given CDRL bulk upload process may upload information associated with only one CDRL deliverable. However, its intended or primary function is for a single CDRL bulk upload to simultaneously or concurrently add information for two or more CDRL deliverables into the system 100. Details of a CDRL bulk upload process are described in further detail below. With respect to the bulk group ID and/or name field 214, a bulk group ID may be a unique identification that identifies those CDRL deliverables added to the CDRL deliverable data 104 as part of a CDRL bulk upload process. CDRL deliverables that are part of the same bulk upload may be considered part of a same bulk group, and in turn have the same bulk group ID. Correspondingly, similar to the CDRL deliverable ID, a bulk group ID may be an alphanumeric value that uniquely identifies a bulk group in the system 100 or at least among various bulk groups under a same program or contract. The bulk group name of a given bulk group may be a word or phrase that identifies or characterizes the given bulk group. In any of various implementations, the bulk group name may or may not be a unique name in the system 100 or among bulk group names under a given or the same program or contract. In addition or alternatively, for at least some implementations, each bulk group name of a given bulk group may be in accordance with a certain, predetermined bulk group nomenclature used to identify or characterize the bulk group and/or indicate a type of the given bulk group. In addition or alternatively, in any of various implementations, a given bulk group ID/name field 214 may include only a bulk group ID, only a bulk group name, or both a bulk group ID and a bulk group name. Also, for simplicity, the bulk group ID and bulk group name are shown as being part of the same field 214. However, in any of various other implementations, the bulk group ID and the bulk group name may be separate pieces of data or information, included in separate fields, separately accessed and/or processed by the controller 112, and/or separately displayed in the CDRL management interface 110.

Also, in event that a given CDRL deliverable is not associated with, or connected to, a bulk group, the bulk group ID/name field 214 may be blank or empty, or may otherwise be populated with a default value, such as a value corresponding to logic ‘0’, which in turn may indicate to the controller 112 that the given CDRL deliverable is not associated with, or connected to, any bulk group. In this way, the value in the bulk group ID/name field 214 may serve as a flag that indicates to the controller 112 whether a given CDRL deliverable is associated with a bulk group. In event that the bulk group ID/name field 214 for a given CDRL deliverable includes a value indicating a particular bulk group, then the controller 112 may determine that the given CDRL deliverable is associated with a bulk group. On the other hand, in event that the bulk group ID/name field 214 for a given CDRL deliverable does not include a value indicating a particular bulk group (such as by being empty or being populated with a default value), then the controller 112 may determine that the given CDRL deliverable is not associated with any bulk group.

In addition, for at least some implementations, each CDRL deliverable entry 202 may include a delivery date field 216. The delivery date field 216 for a given CDRL deliverable may include a value indicate a particular date that the CDRL deliverable is to be delivered. The delivery date may include a value that indicates a particular or a unique day, such as one indicating a particular year, a particular month in the particular year, and a particular day in the particular month. In some implementations, the delivery date may also indicate a particular time within the particular day, such as a time corresponding to “close of business.” As described in further detail below, the controller 112 may calculate or otherwise determine a particular delivery date for a given CDRL deliverable. Upon calculating or determining the particular delivery date, the controller 112 may populate the delivery date field 216 with the particular delivery date. Also, in event that the controller 112 has not yet calculated or determined a delivery date for a given CDRL deliverable, the delivery date field 216 may be blank or empty or may include a predetermined value, such as a value indicating a logic ‘0’, which in turn may indicate that the delivery date for the given CDRL deliverable is not yet determined. Additionally, in event that the delivery date has been updated or revised, the controller 112 may populate or overwrite the delivery date field 216 with the updated or revised delivery date. Ways that the controller 112 calculates or determines delivery dates for CDRL deliverables are described in further detail below.

In addition, for at least some implementations, each CDRL deliverable entry 202 may include a delivery date calculation rule field 218. In general, a delivery date calculation rule may include information that the controller 112 uses to calculate a delivery date for a given CDRL deliverable. In particular examples, a given delivery date calculation rule is associated with, or connected to, a particular milestone. More particularly, a given delivery date calculation rule may identify a certain amount of time, such as a certain number of days, before or after a particular milestone date. Non-limiting examples may include 30 days before a given milestone date or 45 days after a given milestone date. For such examples, the controller 112 may use a given delivery date calculation rule for a given CDRL deliverable, along with a milestone date of a milestone to which the given delivery date calculation rule is connected, in order to determine a delivery date for the given CDRL deliverable. Also, in event that a given CDRL deliverable is not associated with a delivery date calculation rule, such as by not being associated with a milestone, then the delivery date calculation rule field 218 may be empty or blank or may be otherwise populated with a default value, such as a value indicating a logic ‘0’, which in turn may indicate that the given CDRL deliverable is not associated with any delivery date calculation rule.

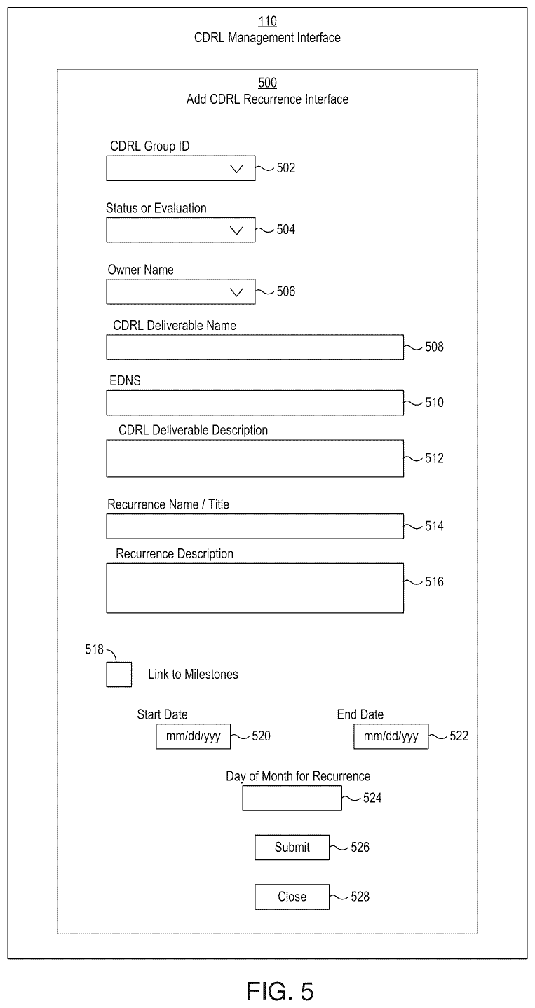

Additionally, for instances where a given CDRL deliverable is part of a CDRL recurrence and the CDRL recurrence is not associated with a set of milestones, the delivery date calculation rule may include information that the controller 112 may use to determine delivery dates for each of the CDRL deliverables that are part of the CDRL recurrence. In some examples, such information that may be part of a delivery date calculation rule may include a start date of the CDRL recurrence, an end date of the CDRL recurrence, and a day-of-month for the CDRL recurrence, as described in further detail below with respect to FIG. 5.

In addition, for at least some implementations, each CDRL deliverable entry 202 may include a delivery status field 220 and/or a delivery evaluation field 222. In general a delivery status of a given CDRL deliverable may indicate whether or not the CDRL deliverable has been delivered. Accordingly, the value in the delivery status field 220 may serve as a flag that indicates to the controller 112 whether or not the CDRL deliverable has been delivered. Also, a delivery evaluation may indicate a value associated with, or based on a comparison of, the delivery status and the delivery date. For example, in event that a given CDRL deliverable has not yet been delivered, but the delivery date has not yet occurred, the delivery evaluation may be “on track” with respect to status or a similar indication. Also, in event that a given CDRL deliverable has not yet been delivered and the delivery date has passed, then the delivery evaluation may be “late” or “overdue”, or a similar indication. Additionally, in event that a given CDRL deliverable has been delivered before or on the delivery date, then the delivery evaluation may be “delivered”, “satisfied”, “timely submitted”, or a similar indication. Also, in event that a given CDRL deliverable has been delivered after the delivery date, then the deliver evaluation may be “delivered”, “delivered late”, or a similar indication. Various ways of implementing the delivery status field 220 and/or the delivery evaluation field 222 may be possible. For example, in any of various implementations, each CDRL deliverable entry 202 may include only a delivery status field 220, only a delivery evaluation field 222, or both a delivery status field 220 and a delivery evaluation field 222.

In addition, for at least some implementations, each CDRL deliverable entry 202 may include a customer feedback field 224. The customer feedback field 224 may include feedback a customer (e.g., a governmental agency) that issued or awarded the contract has to a related CDRL deliverable that the customer received. For example, if a given CDRL deliverable is an update to an earlier CDRL deliverable due to the customer providing feedback to the earlier CDRL deliverable, then the customer feedback field 224 may be populated with the customer's feedback. Correspondingly, if the customer does not have any feedback, then the customer feedback field 224 may be empty. In this way, the customer feedback field 224 may serve as a flag indicating whether or not there is customer feedback associated with a given CDRL deliverable. That is, the customer feedback field 224 populated with customer feedback may indicate that the customer has provided feedback for an associated CDRL deliverable, whereas the customer feedback field 224 being empty may indicate that that the customer has not provided feedback for the associated CDRL deliverable. In some examples, a term such as “rework” may be populated in the customer feedback field 224, indicating that the customer wants an associated CDRL deliverable to be updated or “reworked”.

In addition, for at least some implementations, each CDRL deliverable entry 202 may include a deliverable content link field 226. The deliverable content link field 226 for a given CDRL deliverable may include a link to the electronic content, such as an electronic document and/or other electronic media, that is to be delivered as part of the given CDRL deliverable. In at least some implementations, the deliverable content link may be configured in the CDRL management interface 110 for display using the display device 108, and when displayed, may be configured to be triggered by a user input, such as a mouse click or an input onto a touchscreen of the display device 108. When triggered, the deliverable content link may cause the electronic content to be displayed by the display device 108, which may then be viewed and/or modified (e.g., edited).

In addition, for at least some implementations, each CDRL deliverable entry 202 may include a comments field 228. The comments field 228 for a given CDRL deliverable may include comments that a user input to the CDRL management interface 110. Comments may include information or notes about the CDRL deliverable content associated with the given CDRL deliverable, information about prior versions of the CDRL deliverable content, information related to customer feedback, or any other information that a user may input into the CDRL management interface 110 to facilitate optimal management of the CDRL deliverable with respect to the content of the given CDRL deliverable and/or timely transmission of the given CDRL deliverable.

In addition, for at least some implementations, each CDRL deliverable entry 202 may include an owner ID and/or an owner name field 230. In general, an owner of a given CDRL deliverable may be a person designated to transmit the given CDRL deliverable and/or a person designed to give final approval of the electronic content to be transmitted as part of the given CDRL deliverable. An owner ID may be an alphanumeric value that uniquely identifies an owner that uses the system 100 or at least among various owners transmitting and/or preparing CDRL deliverables under a same program or contract. The owner name may be the name of a given owner. In addition, in any of various implementations, a given owner ID/name field 230 may include only an owner ID, only an owner name, or both an owner ID and an owner name. Also, for simplicity, the owner ID and owner name are shown as being part of the same field 230. However, in any of various other implementations, the owner ID and the owner name may be separate pieces of data or information, included in separate fields, separately accessed and/or processed by the controller 112, and/or separately displayed in the CDRL management interface 110. Also, in event that a given CDRL deliverable is not associated with, or connected to, an owner, the owner ID/name field 230 may be blank or empty, or may otherwise be populated with a default value, such as value corresponding to logic ‘0’, which in turn may indicate to the controller 112 that the given CDRL deliverable is not associated with, or connected to, any owner.

In addition, for at least some implementations, each CDRL deliverable entry 202 may include a program ID and/or a program name field 232. In general, a program of a given CDRL deliverable may be the program or contract under which the CDRL deliverable is set forth, specified, and/or created. A program ID may be an alphanumeric value that uniquely identifies the program. The program name may the name of the program. For simplicity, the program ID and the program name are shown as being part of the same field 232. However, in any of various other implementations, the program ID and the program name may be separate pieces of data or information, included in separate fields, separately accessed and/or processed by the controller 112, and/or separately displayed in the CDRL management interface 110.

In addition, for at least some implementations, each CDRL deliverable entry 202 may include an extension mechanisms for domain name system (EDNS) field 234. The EDNS field 234 may be populated with a unique EDNS number for serial number-like identification purposes. In some implementations, the EDNS number includes or is otherwise appended or associated with a revision number that indicates whether the associated CDRL deliverable is an initial version or an nth revised version.

Implementations other than the one shown in FIG. 2 may include more or fewer fields than the fields 204-234 for each of the CDRL deliverable entries 202.

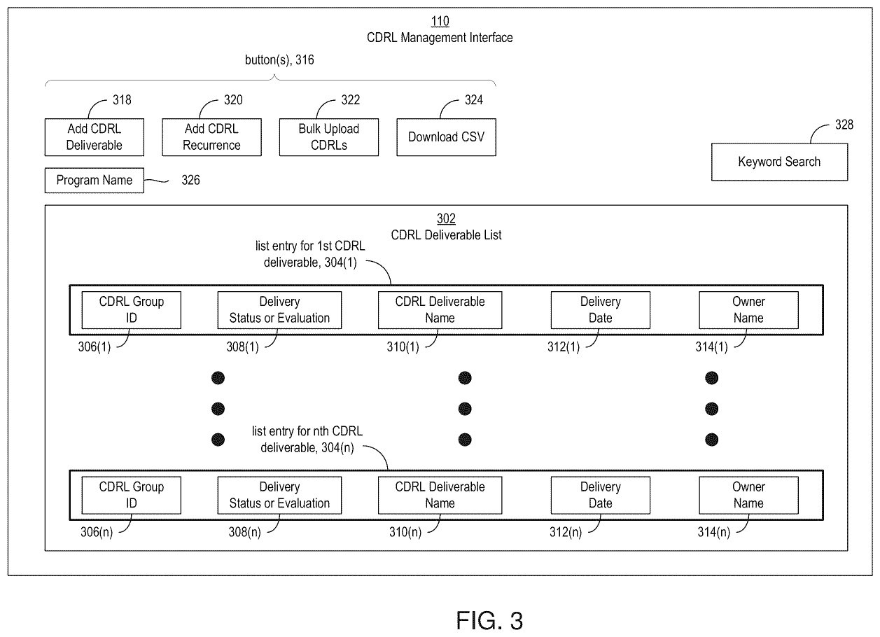

FIG. 3 shows an example schematic view of the CDRL management interface 110 when displayed by the display device 108. In the example schematic view of FIG. 3, the CDRL management interface 110 is configured with a CDRL deliverable list 302 that includes one or more list entries 304 for one or more CDRL deliverables. That is, each list entry 304 in the CDRL deliverable list 302 may be associated with a given CDRL deliverable, and may include CDRL deliverable information or data associated with the given CDRL deliverable. FIG. 3 shows the CDRL deliverable list 302 including a first list entry 304(1) for a first CDRL deliverable, and extending to an nth list entry 304(n) for an nth CDRL deliverable. During operation, the CDRL deliverable list 302 may include no list entries, only one list entry 304, or two or more list entries 304.

In addition, each list entry 304 for a given CDRL deliverable may correspond to a given database entry 202 for the given CDRL deliverable. Accordingly, a given list entry 304 for a given CDRL deliverable may include some or all of the information or data included in a given database entry 202 for the given CDRL deliverable. In the example shown in FIG. 3, each list entry 304 may include an associated CDRL group ID 306, an associated delivery status or evaluation 308, an associated CDRL deliverable name 310, an associated delivery date 312, and an associated owner name 314. For a given CDRL deliverable, the CDRL group ID 306 may correspond to, or be the same as, the CDRL group ID included in the CDRL group ID field 208 in the database entry 202 for the given CDRL deliverable; the delivery status or evaluation may correspond to, or be the same as, the deliver status or evaluation included in the delivery status field 220 or the delivery evaluation field 222 for the given CDRL deliverable; the CDRL deliverable name 310 may correspond to, or be the same as, the CDRL deliverable name included in the CDRL deliverable ID/name field 204 for the given CDRL deliverable; the delivery date 312 may correspond to, or be the same as, the delivery date included in the delivery date field 216 for the given CDRL deliverable; and the owner name 314 may correspond to, or be the same as, the owner name included in the owner ID/name field 230 for the given CDRL deliverable.

During operation, when the display device 108 is to display the CDRL management interface 108 with the CDRL deliverable list, the controller 112 may be configured to access the CDRL deliverable data 104 and retrieve the values or other data in the fields 204-234 in order to display the list entries 304 with the values or other data 306-314.

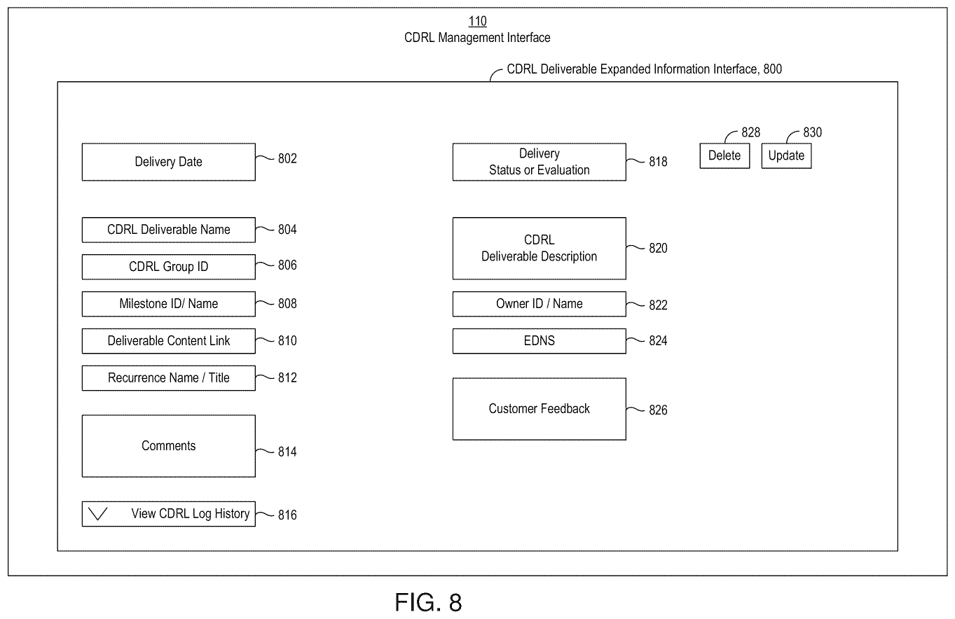

In some implementations, one or more items in the list entries 304 for a given CDRL deliverable, such as CDRL deliverable name 310 for example, may be configured as a link that can be activated, such as by a mouse click, a user input onto a touch screen, or other similar input. When the link is activated, another interface particularly for the given CDRL deliverable associated with the CDRL deliverable name 310 may appear, such as over the CDRL deliverable list 302. The other interface may include or display any of various information associated with the given CDRL deliverable, which may include any of the various information populated in the fields 204-234, including information that may not be included in the list entries 304. For example, the interface may include comments such as those included in the comments field 228 or a deliverable content link included in the deliverable content link field 226. This may allow the user to view supplemental information about the CDRL deliverable, such as prior owners of the CDRL deliverable, or quick access to the document being worked on that will be submitted as part of the CDRL deliverable. Further details of such another interface is described in further detail below with respect to FIG. 8.

Additionally, in some implementations, the CDRL management interface 110 may include one or more user interface (UI) elements 316 positioned adjacent to the CDRL deliverable list 302, or otherwise displayed simultaneously with the CDRL deliverable list 302. In some implementations such as in FIG. 3, the one or more UI elements 316 may be in the form of pressable buttons, although other UI elements with the same or similar functionality may be possible in any other of various implementations. The one or more UI elements 316 may include one or more of an add CDRL deliverable UI element 318, an add CDRL recurrence UI element 320, a bulk upload CDRLs UI element 322, and a download comma separated variable (CSV) UI element 324.

The add CDRL deliverable UI element 318 may, when pressed or otherwise triggered, enable a user to add a new CDRL deliverable to the system 100. Upon the new CDRL deliverable being added, a new database entry 202 for the new CDRL deliverable may be included as part of the CDRL deliverable data 104, and/or a new list entry 304 for the new CDRL deliverable may be included and displayed in the CDRL deliverable list 302.

The add CDRL recurrence UI element 320 may, when pressed or otherwise triggered, enable a user to add a new CDRL recurrence to the system 100. Upon the new CDRL recurrence being added, new database entries 202 for new CDRL deliverables that are part of the new CDRL recurrence may be included as part of the CDRL deliverable data 104, and/or new list entries 304 for the new CDRL deliverables may be included and displayed in the CDRL deliverable list 302.

The bulk upload CDRLs UI element 322 may, when pressed or otherwise triggered, initiate or trigger a CDRL bulk upload process. As previously described, the system 100 may be configured to perform a CDRL bulk upload process, during which information associated with at least one CDRL deliverable is uploaded or added into the system 100 for subsequent access, processing, and/or display. In some implementations of a CDRL bulk upload process, a user may upload an electronic document into the system 100 via the CDRL management interface 110. The electronic document may be in the form of a spreadsheet, a table, or other similar format capable of listing multiple CDRL deliverables and associated information. Upon the electronic document being uploaded, the controller 112 may analyze the information included in the electronic document and generate a number of CDRL deliverable entries 202 in the CDRL deliverable data 104 corresponding to the CDRL deliverables and associated information listed in the electronic document. Corresponding CDRL list entries 306 for the CDRL deliverables identified in the electronic document and/or uploaded as part of the CDRL bulk upload process may also be created and displayed in the CDRL deliverable list 302. Additionally, in some implementations, when the bulk upload CDRLs UI element 322 is triggered (e.g., pressed or clicked), a template of the electronic document may be displayed in the CDRL management interface 110, which a user may populate with information for one or more CDRL deliverables. After the template is populated, the user may electronically submit the populated template into the system 100, such as via the CDRL management interface 110. In response, the controller 112 may complete the CDRL bulk upload process, such as by creating one or more database entries 202 and/or one more list entries 304 corresponding to the CDRL information included in the electronic document. In other implementations, a user may populate an electronic document separately without display of a template in response to the triggering of the bulk upload CDRLs UI element 322 and/or before the bulk upload CDRLs UI element 322 is pressed. In such implementations for example, an interface may be displayed that prompts the user to identify to the system 100 where the electronic document is electronically stored. Upon receiving the identification from the user, the controller 112 may access or retrieve the electronic document from storage and, in turn, complete the CDRL bulk upload process using the CDRL deliverable information included in the electronic document. Various ways of implementing a CDRL bulk upload process to upload information for two or more CDRL deliverables simultaneously or concurrently may be possible.

The download CSV UI element 324 may, when pressed or otherwise triggered, may initiate a download of the CDRL deliverable list 302 in a document having a CSV format to a local storage of a computing device connected to and/or controlling the display device 108. Formats other than CSV may be possible in any of various implementations.

The configuration of UI elements 316 in the CDRL management interface 110 shown in FIG. 3 is merely an example of GUI features that may be used to facilitate the addition of new CDRL deliverables and/or recurrences, bulk uploads, and/or CSV downloads. Other configurations including more or fewer UI elements than the UI elements 318-324 may be possible. For example, another configuration may have only one UI element to add one or more CDRL deliverables, instead of separate UI elements 318 and 320 to separately create one or more new CDRL entries for a single CDRL deliverable or a CDRL recurrence.

Additionally, in some implementations as shown in FIG. 3, the CDRL management interface 110 may also include an area 326 where the program name is displayed simultaneously with the CDRL deliverable list 302 and/or the UI element(s) 316. In addition or alternatively, the CDRL management interface 110 may include a keyword UI element, such as in the form of a text box, 328 configured to receive keyword inputs. Upon entry of the keyword input, the controller 112 may be configured to search the data in the list entries 304. The controller 112, via the display 108, may be configured to highlight data in any of the various list entries 304 that matches the keyword input.

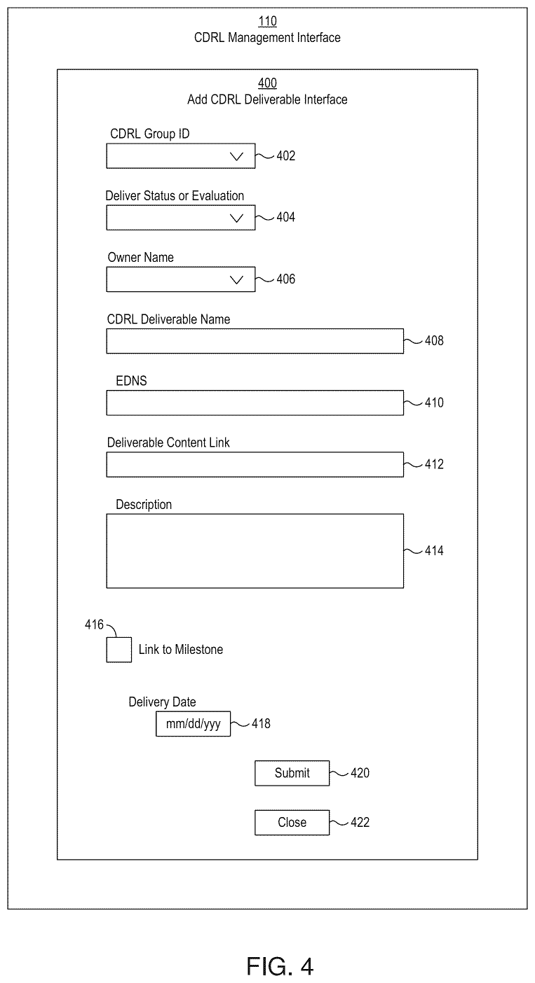

FIG. 4 shows a schematic view of an example add CDRL deliverable interface 400 configured in the CDRL management interface 110. Referring also to FIG. 3, when a user triggers the add deliverable UI element 318 (such as by pressing or clicking the add deliverable UI element 318) in order to add a CDRL deliverable to the system 100, the triggering may cause the add CDRL deliverable interface 400 to be displayed. For example, the controller 112 may detect the input on the add CDRL deliverable UI element 318, and in response, may cause the add CDRL deliverable interface 400 to be displayed in the CDRL management interface 110 via the display device 108.

In general, the add CDRL deliverable interface 400 includes a plurality of UI elements, such as in the form of input boxes, that allow a user to enter information about a new CDRL deliverable into the system 100 via the CDRL management interface 110 displayed on the display device 108. In the example in FIG. 4, the add CDRL deliverable interface 400 may include a CDRL group ID input box 402, a delivery status or evaluation box 404, an owner name input box 406, a CDRL deliverable name input box 408, a EDNS input box 410, a deliverable content link input box 412, a description input box 414, a link to milestone input box 416, a delivery date input box 418, a submit UI element (such as a button or other similar UI element) 420, and a close UI element 422. Each of the submit and close UI elements 420, 422 may be in the form of a button such as shown in FIG. 4, although other types of UI elements with the same or similar functionality may be possible.

The CDRL group ID input box 402 may be configured to receive a CDRL group ID for a given new CDRL deliverable to be added. In some implementations as shown in FIG. 4, the CDRL group ID input box 402 may provide a drop down menu including one or more candidate CDRL group IDs that a user can select. For example, a user may initially select the “v” icon in the CDRL group ID input box 402, which may trigger display of a list of one or more candidate CDRL group IDs that a user can select. The user may then select one of the candidate CDRL group IDs in the drop down menu. Other types of input boxes for the CDRL group ID input box 402, such as a text box configured to receive a text input for the CDRL group ID may be possible.

The delivery status or evaluation input box 404 may be configured to receive a delivery status or evaluation for a given new CDRL deliverable to be added. In some implementations as shown in FIG. 4, the delivery status or evaluation input box 404 may provide a drop down menu including one or more candidate delivery statuses or evaluations that a user can select. For example, a user may initially select the “v” icon in the delivery status or evaluation input box 404, which may trigger display of a list of one or more candidate delivery statuses or evaluations that a user can select. The user may then select one of the candidate delivery statuses or evaluations in the drop down menu. Other types of input boxes for the delivery status or evaluation input box 404, such as a text box configured to receive a text input for the delivery status or evaluation may be possible.

The owner name input box 406 may be configured to receive an owner name for a given new CDRL deliverable to be added. In some implementations as shown in FIG. 4, the owner name input box 406 may provide a drop down menu including one or more candidate owner names that a user can select. For example, a user may initially select the “v” icon in the owner name input box 406, which may trigger display of a list of one or more candidate owner names that a user can select. The user may then select one of the candidate owner names in the drop down menu. Other types of input boxes for the owner name input box 406, such as a text box configured to receive a text input for the owner name may be possible.

Additionally, the CDRL deliverable name input box 408 may be configured to receive an input, such as a text input, indicating a CDRL deliverable name for the given new CDRL deliverable. The EDNS input box 410 may be configured to receive an input, such as a text input, indicating an EDNS for the given new CDRL deliverable. The deliverable content link input box 412 may be configured to receive an input, such as a text input, indicating a deliverable content link for the given new CDRL deliverable. The description input box 414 may be configured to receive an input, such as a text input, indicating a description of the given CDRL deliverable, which may be used to supplement the CDRL deliverable ID and/or the CDRL deliverable name for the given new CDRL deliverable.

In addition, in some implementations, the link to milestone input box 416 is a checkbox configured to receive an input that serves as a flag indicating that the new given CDRL deliverable is associated with, or connected to, a milestone. That is, upon submission of the information entered into the add CDRL deliverable interface 400, in event that the check box 416 is checked, then the new given CDRL deliverable is associated with a milestone in the CDRL database 102. On the other hand, in event that the check box 416 is not checked, then the new given CDRL deliverable is not associated with a milestone in the CDRL database 102. For at least some implementations, the system 100 may be configured to associate CDRL group IDs with milestones. Accordingly, if the check box 416 is checked, then upon submission of the information to add a new CDRL deliverable, the controller 112 may determine a milestone ID and/or a milestone name associated with the given new CDRL deliverable based on an association between the CDRL group ID and a milestone. In other implementations, the link to milestone input box 416 is a text input that allows a user to enter in a milestone ID and/or a milestone name. The milestone ID and/or the milestone name, itself, serves as a flag to indicate whether the given new CDRL deliverable is associated with a milestone.

As shown in FIG. 4, the add CDRL deliverable interface 400 does not include an input box for a CDRL deliverable ID. For such configurations, the controller 112 may be configured to generate a new CDRL deliverable ID for the given new CDRL deliverable, such as upon submission of the information entered into the add CDRL deliverable interface 400 for the given new CDRL deliverable. In this way, a CDRL deliverable ID assigned to a newly added CDRL deliverable is a system-generated (or a computer-generated) value, as opposed to a value devised by a user and input into the system 100 via a user input.

The delivery date input box 418 is configured to receive a delivery date for the given new CDRL deliverable. For example, in event that the given new CDRL deliverable is not associated with a milestone, a user may directly input a delivery date for the given new CDRL deliverable. In turn, the controller 112 may use the input deliver date as the delivery date for the given new CDRL deliverable, as described in further detail below. On the other hand, in event that the given new CDRL deliverable is associated with a milestone (e.g., the check box 416 is checked), then the controller 112 may deactivate the delivery date input box 418 since the controller 112 may calculate the delivery date of the given new CDRL deliverable according to a milestone date and a delivery date calculation rule.

Also, the submit UI element 420 may be triggered, such as in response to a user input, to submit the information entered into the input boxes 402-418. Upon the submit UI element 420 being triggered, the information entered into the input boxes 402-418 may be used by the controller 112 to create a new database entry 202 for the given new CDRL deliverable in the CDRL deliverable data 104, and/or a new list entry 304 for the given new CDRL deliverable in the CDRL deliverable list 302. For at least some implementations, when the submit UI element 420 is triggered, the triggering causes the add CDRL deliverable interface 400 to be automatically closed out, and the CDRL management interface 110 may directly display (or directly return to displaying) the CDRL deliverable list 302, now with the new list entry 304 for the given new CDRL deliverable. Also, the close UI element 422 may be triggered to close out the add CDRL deliverable interface 400 without submission of any information to create a new CDRL deliverable.

The configuration of input boxes and buttons in FIG. 4 is merely an example, and other configurations, including those having more or fewer input boxes, buttons, and/or other similar types of UI elements to add a new CDRL deliverable, and/or including those positioning the input boxes, buttons, and/or other UI elements in different locations within an area defining an add CDRL deliverable interface 400, may be possible.

FIG. 5 shows a schematic view of an add CDRL recurrence interface 500 configured in the CDRL management interface 110. Referring also to FIG. 3, when a user triggers the add recurrence UI element 320 (such as by pressing or clicking the add recurrence UI element 320) in order to add a CDRL recurrence to the system 100, the triggering may cause the add CDRL recurrence interface 500 to be displayed. For example, the controller 112 may detect the input on the add CDRL recurrence UI element 320, and in response, may cause the add CDRL recurrence interface 500 to be displayed in the CDRL management interface 110 via the display device 108.

In general, the add CDRL recurrence interface 500 includes a plurality of UI elements, such as in the form of input boxes, that allow a user to enter information about a new CDRL recurrence into the system 100 via the CDRL management interface 110 displayed on the display device 108. In the example in FIG. 5, the add CDRL recurrence interface 500 may include a CDRL group ID input box 502, a delivery status or evaluation box 504, an owner name input box 506, a CDRL deliverable name input box 508, a EDNS input box 510, a CDRL deliverable description input box 512, a recurrence name or title input box 514, a recurrence description input box 516, a link to milestones input box 518, a start date input box 520, an end date input box 522, a day-of-month recurrence input box 524, a submit UI element 526, and a close UI element 528.

Similar to the add CDRL deliverable interface 400, in the add CDRL recurrence interface 500, the CDRL group ID input box 502 may be configured to receive a CDRL group ID for a given new CDRL recurrence to be added. In some examples, the CDRL group ID input box 502 may receive the group ID as a text input or as a selection from a drop down menu, as previously described.

The delivery status or evaluation input box 504 may be configured to receive a delivery status or evaluation for a given new CDRL recurrence to be added. In some examples, the delivery status or evaluation input box 504 may receive a delivery status or evaluation as a text input or as a selection from a drop down menu, as previously described for the delivery status or evaluation input box 404 of FIG. 4.

The owner name input box 506 may be configured to receive an owner name for a given new CDRL recurrence to be added. In some examples, the owner name input box 506 may receive an owner name as a text input or as a selection from a drop down menu, as previously described for the owner name input box 406 of FIG. 4.

Additionally, the CDRL deliverable name input box 508 may be configured to receive an input, such as a text input, indicating a CDRL deliverable name for given new CDRL deliverables that are part of the new CDRL recurrence. The EDNS input box 510 may be configured to receive an input, such as a text input, indicating an EDNS for the given new CDRL deliverable. The CDRL deliverable description input box 414 may be configured to receive an input, such as a text input, indicating a description of the new CDRL deliverables that are part of the new CDRL recurrence, which may be used to supplement the CDRL deliverable IDs and/or the CDRL deliverable name for the given new CDRL deliverables of the new recurrence being added.

Also, the recurrence name input box 514 may be configured to receive an input, such as a text input, indicating a recurrence name for given new CDRL recurrence. The recurrence description input box 516 may be configured to receive an input, such as a text input, indicating a description of the new CDRL recurrence, which may be used to supplement the CDRL recurrence ID, the CDRL recurrence name for the given new CDRL recurrence, and/or the CDRL deliverable name and/or CDRL deliverable description for the new CDRL deliverables that are part of the new CDRL recurrence.

In addition, in some implementations, the link to milestones input box 518 is a checkbox configured to receive an input that serves as a flag indicating that the new given CDRL recurrence is associated with, or connected to, a set of milestones. That is, upon submission of the information entered into the add CDRL recurrence interface 500, in event that the check box 518 is checked, then the new CDRL deliverables that are part of the given new CDRL recurrence being added are associated with a set of milestones in the CDRL database 102. On the other hand, in event that the check box 518 is not checked, then the new CDRL deliverables that are part of the given new CDRL recurrence being added are not associated with a set of milestones in the CDRL database 102. As previously described with respect to FIG. 4, for at least some implementations, the system 100 may be configured to associate CDRL group IDs with milestones. Accordingly, if the check box 518 is checked, then upon submission of the information to add a new CDRL recurrence, the controller 112 may determine a set of milestones IDs and/or a set of milestone names associated with the given new CDRL recurrence based on an association between the CDRL group ID and a set of milestones. In other implementations, the link to milestone input box 518 is a text input that allows a user to enter in a set of milestone IDs and/or a set of milestone names. The set of milestone IDs and/or the set of milestone names, itself, serves as a flag to indicate whether the given new CDRL recurrence is associated with a set of milestones.

As shown in FIG. 5, the add CDRL recurrence interface 500 does not include an input box for a CDRL recurrence ID. For such configurations, the controller 112 may be configured to generate a new CDRL recurrence ID for the given new CDRL recurrence, such as upon submission of the information entered into the add CDRL recurrence interface 500 for the given new CDRL deliverable. In this way, similar to the CDRL deliverable ID, a CDRL recurrence ID assigned to a newly added CDRL recurrence is a system-generated value, as opposed to a value devised by a user and input into the system 100 via a user input.

The start date input box 520 is configured to receive a start date for the given new CDRL recurrence. The start date is a delivery date for an initial CDRL deliverable that is part of the given new CDRL recurrence. In other words, it is the first or earliest delivery date for the new CDRL recurrence. For example, if a new recurrence specifies that CDRL deliverables that are part of the new CDRL recurrence are to be submitted on the 15th of every month, the start date may identify an initial month when an initial CDRL deliverable of the new CDRL recurrence is to be submitted. Similarly, an end date input box 522 is configured to receive an end date for the given new CDRL recurrence. The end date is a delivery date for a last CDRL deliverable that is part of the given new CDRL recurrence. In other words, it is the last or latest delivery date for the new CDRL recurrence. Using the above example, if a new recurrence specifies that CDRL deliverables that are part of the new CDRL recurrence are to be submitted on the 15th of every month, the end date may identify a last month when a last or final CDRL deliverable of the new CDRL recurrence is to be submitted. Also, the day-of-month for recurrence input box 524 is configured to receive a number indicating a day of the month on which each CDRL deliverable of the new CDRL recurrence is to be submitted. Using the above example, a user would enter “15” into the day-of-month for recurrence input box 524 in order for the system 100 to recognize that CDRL deliverables for the new CDRL recurrence are to be submitted on the 15th of each month.

Other input boxes to establish a CDRL recurrence for different temporal options are possible. For example, another input box may enable a user to set a day of the week that CDRL deliverables of a recurrence are to be submitted. As another example, an input box may enable a user to set a recurrence interval for longer than once per month, such as where CDRL deliverables for a CDRL recurrence are to be delivered once every X months, where X is two or more.

In some implementations, the start date, end date, and day-of-month for recurrence information may be included as part of the delivery date calculation rule, as previously described. For example, after the information for the new CDRL recurrence is submitted, the controller 112 may access the start date, the end date, and the day-of-month for recurrence information in the delivery date calculation rule field 218 in order to determine delivery dates respectively for each of the CDRL deliverables that are part of the new CDRL recurrence. On the other hand, in event that the given new CDRL recurrence is associated with a set milestones (e.g., the check box 518 is checked), then the controller 112 may deactivate the start date input box 520, the end date input box 522, and the day-of-month for recurrence input box 524 since the controller 112 may calculate the delivery dates for the CDRL deliverables of the new CDRL recurrence according to milestone dates of the set of milestones and a delivery date calculation rule for the recurrence.

Also, the submit UI element 526 may be triggered, such as in response to a user input (e.g., a user click or a button press), to submit the information entered into the input boxes 502-524. Upon the submit UI element 526 being triggered, the information entered into the input boxes 502-524 may be used by the controller 112 to create a new database entry 202 for new CDRL deliverables that are part of the newly added CDRL recurrence in the CDRL deliverable data 104, and/or new list entries 304 for the new CDRL deliverables in the CDRL deliverable list 302. For at least some implementations, when the submit UI element 526 is triggered, the triggering causes the add CDRL recurrence interface 500 to be automatically closed out, and the CDRL management interface 110 may directly display (or directly return to displaying) the CDRL deliverable list 302, now with the new list entries 304 for the new CDRL deliverables of the given new CDRL recurrence. Also, the close UI element 528 may be triggered to close out the add CDRL recurrence interface 500 without submission of any information to create a new CDRL recurrence.

The configuration of input boxes and buttons in FIG. 5 is merely an example, and other configurations, including those having more or fewer input boxes, buttons, or other UI elements to add a new CDRL recurrence, and/or including those positioning the input boxes, buttons, and/or other UI elements in different locations within an area defining an add CDRL recurrence interface 500, may be possible.

Also, other implementations may not include separate add CDRL deliverable and add CDRL recurrence interfaces 400, 500 as shown in FIGS. 4 and 5. For example, other implementations may include a single interface through which a user can add a single CDRL deliverable not associated with any recurrence or one or more CDRL deliverables associated with a recurrence. Accordingly, various ways of implementing at least one interface to allow a user to enter at least one new CDRL deliverable and associated information into the system 100, with or without the at least one new CDRL deliverable being associated with a recurrence, are possible.

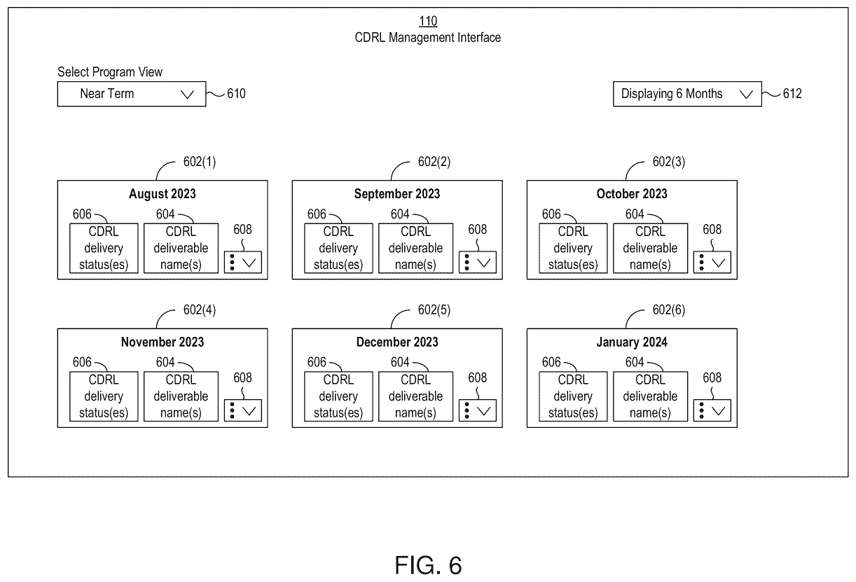

FIG. 6 shows a schematic view of a near term view of the CDRL management interface 110. As shown in FIG. 6, the CDRL management interface 110 may be configured to display information about CDRL deliverables in separate discrete areas 602 based on delivery dates and organized or arranged on a month-by-month basis. For example, the CDRL management interface 110 may be configured to display at least two areas 602, with each area defined by a border, so as to visually demarcate or distinguish the areas 602 from each other. In some examples such as shown in FIG. 6, each area 602 may correspond to a particular month of a particular year, and the particular months that are displayed are sequential in chronological order. For example, FIG. 6 shows six areas 602(1), 602(2), 602(3), 602(4), 602(5), 602(6) sequentially extending in chronological order on a month-by-month basis from August 2023 to January 2024. Other configurations may show areas 602 for months that do not sequentially extend. For example, other configurations may show a first area 602 for August 2023, a second area 602 for February 2024, and a third area for July 2026, without necessarily showing other boxes for months in between those dates. Other configurations may separate areas according to date ranges without those date ranges necessarily spanning from the first day to a last day of a given month. For example, a first area 602 may correspond to a first date range of Jan. 13 to Feb. 12, 2024, a second area 602 may correspond to a second date range of Feb. 13, 2024 to Mar. 12, 2024, and so on.

Additionally, within each given area 602 corresponding to a given date range or time period (e.g., month), information or data about CDRL deliverables having delivery dates that fall within the given date range may be displayed. For example, information or data about CDRL deliverables having delivery dates falling in August 2023 are displayed in a first area 602(1) assigned the date range (or month) of August 2023, information or data about CDRL deliverables having delivery dates falling in September 2023 are displayed in a second area 602(2) assigned the date range (or month) of September 2023, and so on.

In the example implementation in FIG. 6, the information or data about CDRL deliverables that are displayed within the areas 602 include CDRL deliverable names 604 and associated delivery statuses (and/or evaluations) 606 are displayed. In any of various other example implementations, additional or other information or data for a CDRL deliverable is displayed within the area 602, including any information from a database entry 202 for a given CDRL deliverable as previously described with respect to FIG. 2. For some implementations, a respective control box 608 is associated with each area 602, on which a user may operate to select more, fewer, and/or other information about CDRL deliverables having delivery dates corresponding to a particular area 602. Although not shown, in some implementations, a size of a given area 602 may be enlarged or expanded to show more information about CDRL deliverables displayed in the given area 602. The expanded view of the given area 602 may cause the expanded given area 602 to overlap and hide one or more other areas 602 that are not expanded. Correspondingly, a user may control the expanded given area 602 to decrease the given area 602 back to its original size, such that none of the other areas 602 are hidden. The control box 608 or another similar feature may be used to adjust the sizes of the area 602.

Additionally, as shown in FIG. 6, the CDRL management interface 110 may include a program view input box 610 configured to receive a user input indicating a desired program view. In some configuration such as in FIG. 6, the program view input box 610 enables activation of a drop down menu configured to display a plurality of predetermined program views, and allows for a user to select a predetermined program view from among the plurality of predetermined program views. As shown in FIG. 6, one of the plurality of predetermined program views may include a “near term” program view. When the near term program view is selected in the program view input box 610, the CDRL management interface 110 is configured to display an X-number of areas for an X-number of date ranges (e.g., months), including a current date range (one covering a current day that the CDRL management interface 110 is being used), and an (X−1)-number of subsequent date ranges. In the example implementation in FIG. 6, X is six, although other numbers for X for the near term program view may be possible.

Also, in at least some implementations, predetermined program views other than the near term program view may be possible, such as a “long term” program view for example. In some examples, when the long term program view is selected, the CDRL management interface 110 is configured to show a Y-number of areas for a Y-number of date ranges, including a current date range and a (Y−1)-number of subsequent date ranges, where Y is greater than X. In other examples, Y may not necessarily be greater than X, but an earliest date range may be later in time than a current date that the CDRL management interface 110 is being used. To illustrate, suppose today's date is Feb. 15, 2024. The long term program view may show six areas 602 for six months, starting with a month that is six months later than the month in which today's date falls. That is, the CDRL management interface 110 may display six areas 602, each for a respective one of August 2024, September 2024, October 2024, November 2024, December 2024, and January 2025. Various ways of implementing display of multiple areas to convey a long term view, different from a short term view, are possible.

In addition, in some implementations such as in FIG. 6, the CDRL management interface 110 may include a number-of-months displayed input box 612, which may allow a user to select or input a particular number of areas 602 for a particular number of months to be displayed. In some of these implementations, the number-of-months displayed input box 612 may allow a user to select a particular number of areas 602, irrespective of the predetermined program view selected using the program view input box 610. For example, FIG. 6 shows the number-of-months displayed input box 612 indicating that six areas corresponding to six months are displayed, corresponding to the six areas 602 that are displayed. A user may further engage with the number-of-months displayed input box 612 to select a number of months other than six. For example, the number-of-months displayed input box 612 may provide a drop down menu that allows a user to select a number other than six, such as three, four, or five for example. Upon receiving the selection, the controller 112 may change the CDRL management interface 110 from displaying from six areas 602 to the selected number of areas. Various ways of providing a program view input box 610 and a number-of-months displayed input box 612 to allow a user to view a certain number of areas corresponding to a certain number of date ranges may be possible.

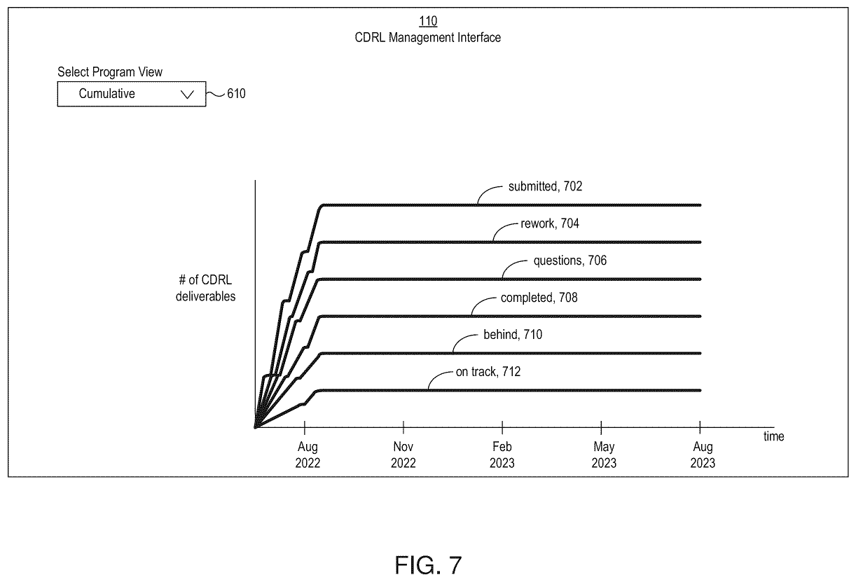

FIG. 7 shows a schematic view of a cumulative view of the CDRL management interface 110. In general, a cumulative view is a graphical display that includes a plot of one or more curves, where each curve is a cumulative number of CDRL deliverables as a function of time. Each curve may be for a respective delivery status, evaluation, or other category for which a given CDRL deliverable may be characterized. In turn, each curve provides a visual representation of a cumulative number of CDRL deliverables that satisfy the criteria for that delivery status, evaluation or other category for any point in time over a date range as identified in the “time” x-axis. An initial or earliest date in the cumulative view may be a start date on which the program started, although other earliest dates may be possible. FIG. 7 shows six curves, each for a respective one of six delivery statuses, evaluations, or other categories, including a first curve 702 for a delivery status of “submitted”, a second curve 704 for a delivery category of “rework”, a third curve 706 for a delivery category of “questions”, a fourth curve 708 for a delivery evaluation of “completed”; a fifth curve 710 for a delivery evaluation of “behind”; and a six curve 712 for a delivery evaluation of “on track”. Other implementations showing fewer curves, or other or additional curves for other delivery statuses, evaluations, or categories may be possible.

Additionally, for at least some implementations such as shown in FIG. 7, the cumulative view may be one of the predetermined program views that may be selected by a user in the program view input box 610. For example, during operation of the CDRL management interface 110, the near term view of FIG. 6 may be displayed, and then the CDRL management interface 110 may switch to the cumulative view of FIG. 7 upon the program view input box 610 receiving an input selecting the cumulative view. The CDRL management interface 110 may then switch back to the near term view of FIG. 6 in event that the program view input box 610 receives another input selecting the near term view.

FIG. 8 shows a schematic view of a CDRL deliverable expanded information interface 800. The CDRL deliverable expanded information interface 800 may be an interface or display view within the CDRL management interface 110 that displays information about a particular CDRL deliverable. For at least some implementations, the CDRL deliverable expanded information interface 800 shows the most information simultaneously for a given CDRL deliverable amongst the various views or interfaces provided or displayed by the CDRL management interface 110. For example, the CDRL deliverable list 302 in FIG. 3 may show a limited or selected amount of information for a single CDRL deliverable in the form of a list entry 304, and display information for multiple CDRL deliverables simultaneously within the CDRL deliverable list 302. In contrast, for at least some implementations, the CDRL deliverable expanded information interface 800 shows information for only a single CDRL deliverable, and the information that is shown is more than the information shown for a single CDRL deliverable in the CDRL deliverable list 302 in FIG. 3.

Addition, the CDRL deliverable expanded information interface 800 may display various information for a single CDRL deliverable in respective or designated areas or locations within the CDRL deliverable expanded information interface 800. In the example configuration shown in FIG. 8, the CDRL deliverable expanded information interface 800 may display, for a single CDRL deliverable, a delivery date, a CDRL deliverable name, a CDRL group ID, a milestone ID and/or a milestone name, a deliverable content link, a recurrence name and/or title, comments associated with the single CDRL deliverable, a CDRL log history, a delivery status or evaluation, a CDRL deliverable description, an owner ID and/or name, an EDNS, and customer feedback in respective areas 802, 804, 806, 808, 810, 812, 814, 816, 818, 820, 822, 824, and 826. The controller 112 may be configured to populate the areas 802-826 for a given CDRL deliverable using the information populated in corresponding fields 204-234 of a database entry 202 for the given CDRL deliverable. For example, the controller 112 may be configured to populate the area 804 with a CDRL deliverable name included in the CDRL deliverable ID/name field 204, and so on.

Of note, a deliverable content link for a given CDRL deliverable displayed in area 810 may be activated by a user via a user input, such as a mouse click or a touchscreen input. The link being activated may cause the controller 112 to retrieve a current version of an electronic document that is to be electronically delivered at least as part of the CDRL deliverable, and display the electronic document to the user in an editable or a read only format. In this way, the CDRL deliverable expanded information interface 800 provides a user with a fast and efficient way to gain access to the electronic document that is to be delivered.

In addition, for at least some implementations such as in FIG. 8, a user may be configured to delete and/or edit all or some of the information associated with a particular CDRL deliverable via the CDRL deliverable expanded information interface 800. For example, as shown in FIG. 8, the CDRL deliverable expanded information interface 800 may include a delete UI element 828 and/or an update UI element 830. Each of the delete and update UI elements 828, 830 may be in the form of buttons, although other types of UI elements may be possible. In event that a user wants to remove a database entry 202 of a given CDRL deliverable in its entirety from the system 200, a user may trigger the delete UI element 828, which may cause all of the information associated with the given CDRL deliverable to be deleted. The deletion may cause the controller 112 to remove the associated database entry 202 from the CDRL deliverable data 104, and in turn any delivery dates or other information associated with the CDRL deliverable from being calculated and/or displayed in any of the views or interfaces of the CDRL management interface 108, such as shown in FIGS. 3-7. Also, in event that a user wants to modify certain information for a given CDRL deliverable, the user can change the certain information in the CDRL deliverable expanded information interface 800, and then trigger the update UI element 830 to confirm the change in the system 100. For example, confirming a change to certain information populated in a given field of a database entry 202 by triggering the update UI element 830 may cause a current version of the certain information to be replaced by an updated version of the certain information in the database entry field. For at least some implementations, one or more of the areas 802-826 may be a UI element, such as in the form of a text box, that enables a user to edit or change the information displayed within the UI element.

Additionally, the information shown in the areas 802-826 in FIG. 8 is merely an example, and any of various information associated with a particular CDRL deliverable, including more or fewer information than that shown in FIG. 8, may be possible in any of various implementations. In addition or alternatively, the particular locations of the areas 802-826 shown in the CDRL deliverable expanded information interface 800 of FIG. 8 is merely an example, and various other configurations of the locations of the areas 802-826 or locations where the CDRL information may be displayed may be possible.

In addition, the CDRL deliverable expanded information interface 800 may be configured to switch from displaying information for one CDRL deliverable to information for another CDRL deliverable, such as in response to a user input. In addition, the CDRL management interface 110 may switch the CDRL deliverable expanded information interface 800 to and/or from any of the other various views or interfaces shown and described with respect to FIGS. 3-7, such as in response to a user input. For example, in some implementations as previously described, the CDRL deliverable list 302 of FIG. 3 may be displayed, showing one or more list entries 304 for one or more CDRL deliverables. A user may activate or click on a particular list entry 304 for a particular CDRL deliverable, which in turn may cause the CDRL deliverable expanded information interface 800 to be activated and show the expanded information for the particular CDRL deliverable, such as in the display configuration shown in FIG. 8. Subsequently, if the user so wants, the user may close out the CDRL deliverable expanded information interface 800, which may automatically cause the CDRL management interface 110 to revert back to showing the CDRL deliverable list 302. In event any updates are made to the information of the particular CDRL deliverable when the CDRL deliverable expanded information interface 800 is activated, such changes may be automatically or instantly displayed in the corresponding list entry 304 when the CDRL management interface 110 reverts back to showing the CDRL deliverable list 302.

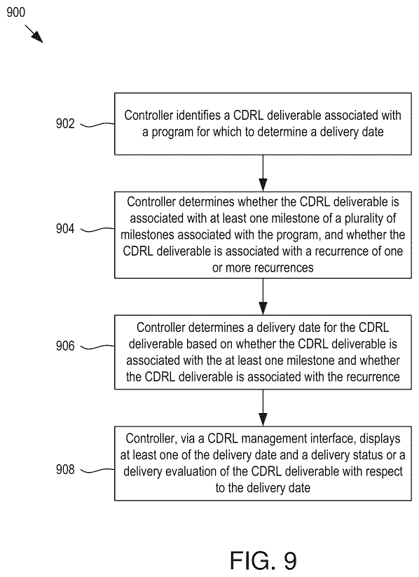

FIG. 9 shows a flow chart of an example method 900 of CDRL deliverable management. At block 902, the controller 112 may identify a CDRL deliverable associated with a program (e.g., a program pursuant to a contract awarded by a customer, such as a governmental agency) for which to determine a delivery date. For example, the controller 112 may determine that it has not yet determined a delivery date for the CDRL deliverable. As another example, the controller 112 may determine that there is an update to the CDRL deliverable information, such as an update to a milestone date, that affects the delivery date of the CDRL deliverable, and turn, determines to calculate an updated delivery date for the CDRL deliverable.

At block 904, the controller 112 determines whether the CDRL deliverable identified at block 902 is associated with at least one milestone (e.g., a single milestone or a set of milestones), and whether the CDRL deliverable is associated with a recurrence. In some implementations, the controller 112 may check or review the database entry 202 for the CDRL deliverable in the CDRL deliverable data 104 to make the determinations at block 904. For example, the controller 112 may check the milestone ID field 210 to determine whether the CDRL deliverable is associated with a milestone. If the milestone ID field 210 indicates a milestone ID, then the controller 112 may determine that the CDRL deliverable is associated with a milestone. Additionally, if the milestone ID field 210 does not indicate a milestone ID, then the controller 112 may determine that the CDRL deliverable is not associated with a milestone. Similarly, the controller 112 may check the recurrence ID field 212 to determine whether the CDRL deliverable is associated with a recurrence. If the recurrence ID field 212 indicates a recurrence ID, then the controller 112 may determine that the CDRL deliverable is associated with a recurrence. Additionally, if the recurrence ID field 212 does not indicate a recurrence ID, then the controller 112 may determine that the CDRL deliverable is not associated with a recurrence.

At block 906, the controller 112 may determine a delivery date for the CDRL deliverable based on whether the CDRL deliverable is associated with the at least one milestone and whether the CDRL deliverable is associated with the recurrence. At block 908, the controller 112, via the CDRL management interface 110, displays a CDRL deliverable name and at least one of the delivery date, a delivery status corresponding to the delivery date, and a delivery evaluation corresponding to the delivery date.

Accordingly, in the example method 900, the controller 112 is configured to identify which of four possible CDRL candidate types the CDRL deliverable belongs or has, and then determine a delivery date for the CDRL deliverable according to the CDRL deliverable type to which the CDRL deliverable belongs. The four CDRL deliverable types include: 1) not associated with a milestone and not associated with a CDRL recurrence; 2) not associated with a milestone and associated with a CDRL recurrence; 3) associated with a milestone and not associated with a CDRL recurrence; and 4) associated with a milestone and associated with a CDRL recurrence. The particular CDRL deliverable type to which the CDRL deliverable belongs may dictate or determine how the controller 112 determines or calculates the delivery date, as previously described.

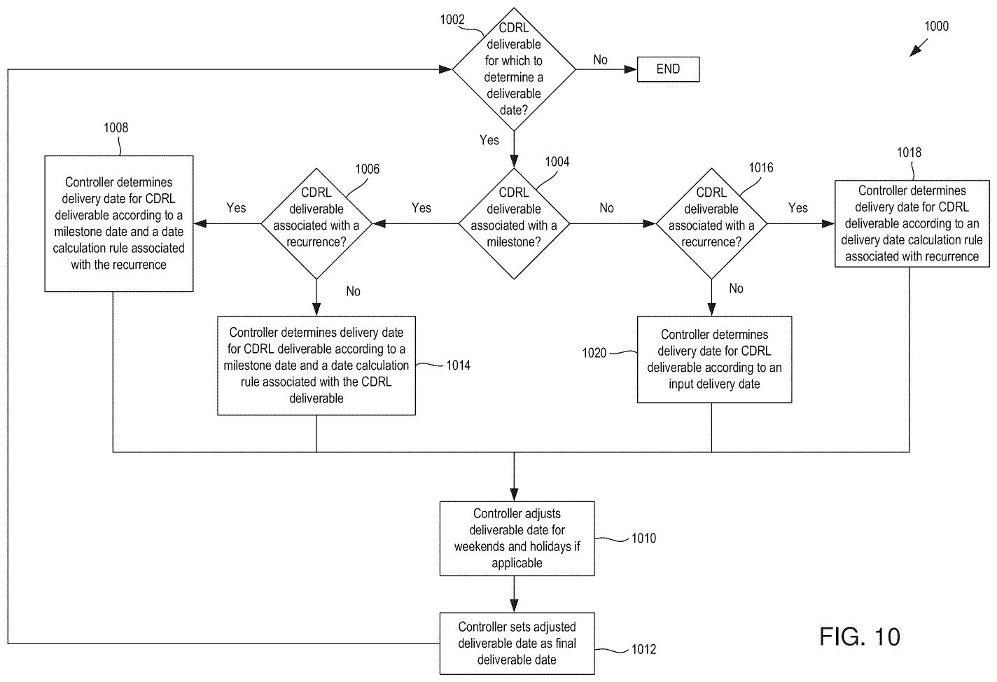

FIG. 10 shows a flow chart of another example method 1000 of CDRL deliverable management. At block 1002, the controller 112 may determine whether there is a CDRL deliverable for which a delivery date is to be determined. For example, the controller 112 may determine that it has not yet determined a delivery date for a CDRL deliverable. To illustrate, a new CDRL deliverable may be added to the system 100, such as via the add CDRL deliverable interface 400, and the controller 112 has not yet determined a delivery date for the new CDRL deliverable. As another illustration, a new CDRL recurrence may be added to the system 100, such as via the add CDRL recurrence interface 500. The controller 112 may determine that it has not determined delivery dates for all of the CDRL deliverables of the CDRL recurrence, and in turn, may determine a delivery date for a CDRL deliverable of the CDRL recurrence for which it has not yet done so. As another example, the controller 112 may determine or detect that there is an update to the CDRL deliverable information, such as an update to a milestone date, that affects the delivery date of a CDRL deliverable, and turn, may determine to calculate an updated delivery date for the CDRL deliverable. If the controller 112 determines that there is no CDRL deliverable for which to determine a delivery date, then the method 1000 may end. Alternatively, if the controller 112 identifies a CDRL deliverable for which to determine a delivery date, then the method may proceed to block 1004.

At block 1004, the controller 112 may determine whether the CDRL deliverable is associated with a milestone. For example, the controller 112 may check a milestone ID field 210 in a database entry 202 for the CDRL deliverable to determine whether the CDRL deliverable is associated with a milestone ID. If so, then the controller 112 may determine that the CDRL deliverable is associated with a milestone. If not, then the controller 112 may determine that the CDRL deliverable is not associated with a milestone.

If the controller 112 determines that the CDRL deliverable is associated with a milestone at block 1004, then at block 1006, the controller 112 may determine whether the CDRL deliverable is associated with a recurrence. For example, the controller 112 may check a recurrence ID field 212 in a database entry 202 for the CDRL deliverable to determine whether the CDRL deliverable is associated with a recurrence ID. If so, then the controller 112 may determine that the CDRL deliverable is associated with a recurrence. If not, then the controller 112 may determine that the CDRL deliverable is not associated with a recurrence.

If the controller 112 determines that the CDRL deliverable is associated with a recurrence at block 1006, then at block 1008, the controller 112 may determine a delivery date for the CDRL deliverable according to the CDRL deliverable being associated with a milestone and being associated with a recurrence. As previously described, a given CDRL recurrence including a plurality of CDRL deliverables may or may not be associated with a set of milestones. In the event that the given CDRL recurrence is associated with a set of milestones, each CDRL deliverable of the given CDRL recurrence is to be delivered relative to a respective milestone date of an associated milestone of the set of milestones. The number of days before or after the respective milestone dates may be part of the delivery date calculation rule included in the database entries 202 for each of the CDRL deliverables of the CDRL recurrence. In turn, the controller 112 may use the CDRL delivery date calculation rule and the milestone dates of the set of milestones to determine respective delivery dates for each of the CDRL deliverables that are part of the CDRL recurrence. Accordingly, for the CDRL deliverable for which a delivery date is to be determined at block 1008, the controller 112 may identify a milestone date associated with the CDRL deliverable. For example, the controller 112 may determine a milestone ID associated with the CDRL deliverable in a milestone ID field 210 for the CDRL deliverable. Then, the controller 112 may identify the milestone date associated with the milestone ID, such as by accessing and querying the milestone database 114 as shown in previously described with respect to FIG. 1. The controller 112 may then calculate a delivery date for the CDRL deliverable according to the milestone date and the delivery date calculation rule.

To illustrate, suppose a given CDRL recurrence includes two CDRL deliverables, including a first CDRL deliverable to be delivered 30 days before a first milestone date of a first milestone of the set of milestones, and a second CDRL deliverable to be delivered 30 days before a second milestone date of a second milestone of the set of milestones. The delivery date calculation rule corresponding to the given CDRL recurrence, and in turn for each of the first and second CDRL deliverables, is 30 days before the milestone date. Suppose then at block 1008 the controller 112 is to calculate a delivery date for the first milestone of the given CDRL recurrence. The controller 112 may do so by determining a first milestone ID of the first milestone, and in turn, determine a first milestone date corresponding to the first milestone ID, such as by accessing the milestone database 114. The controller 112 may then calculate a delivery date for the first CDRL deliverable according to the first milestone date and the delivery date calculation rule for the given CDRL recurrence. That is, the controller 112 may determine the delivery date to be the date that is 30 days before the first milestone date. The controller 112 may make a similar calculation to determine a delivery date for the second CDRL deliverable using a second milestone date for the second milestone and the delivery date calculation rule for the CDRL recurrence.

In some implementations of the method 1000, the delivery date that the controller 112 determines at block 1008 may be a preliminary delivery date, and at block 1010, the controller 112 may determine whether to adjust the preliminary delivery date. For example, in event that the preliminary delivery date falls on a weekend or a holiday, the controller 112 may determine an adjusted delivery date by adjusting the preliminary delivery date to a next day that is not a weekend day (e.g., a Saturday or a Sunday) or a holiday. Also, in event that the preliminary delivery date does not fall on a weekend or a holiday, then the controller 112 may determine not to adjust the preliminary delivery date, or effectively, the adjusted delivery date is the same as the preliminary delivery date. At block 1012, the controller 112 sets the adjusted delivery date determined at block 1010 as a final delivery date for the CDRL deliverable.

Referring back to block 1006, in event that the controller 112 determines that the CDRL deliverable is not associated with a recurrence, then at block 1014, the controller 112 may determine the delivery date for the CDRL deliverable according to the CDRL deliverable being associated with a milestone and not being associated with a recurrence.

Similar to the delivery date determination at block 1008, because the CDRL deliverable for which the delivery date is to be determined at block 1014 is associated with a given milestone, then the controller 112 may calculate the delivery date for the CDRL deliverable according to a milestone date associated with the given milestone, and a delivery date calculation rule associated with the CDRL deliverable. For example, the controller 112 may determine the associated milestone ID in the milestone ID field 210, and then determine the associated milestone date using the milestone ID, such as by accessing the milestone database 114, as previously described. The controller 112 may then calculate the delivery date according to the milestone date and the delivery date calculation rule. To illustrate, suppose a given CDRL deliverable is to be delivered 45 days after a milestone date. Correspondingly, the controller 112 may identify the delivery date calculation rule in the delivery date calculation rule field 218 to be “45 days after the milestone date.” Additionally, the controller 112 may determine the milestone date using the milestone ID in the milestone ID field 210, as previously described. In turn, the controller 112 may determine the delivery date for the CDRL deliverable by determining the date that is 45 days after the milestone date.

For at least some implementations, the controller 112 may consider the delivery date determined at block 1014 as a preliminary delivery date. The method 1000 may then proceed from block 1014 to block 1010, where, as previously described, the controller 112 may determine an adjusted delivery date based on whether the preliminary delivery date falls on a weekend or a holiday. As described, if the preliminary delivery date does not fall on a weekend or holiday, then the adjusted delivery date is the same as the preliminary delivery date. The method 1000 may then proceed to block 1012, where the controller 112 sets the adjusted delivery date as the final delivery date for the CDRL deliverable.

Referring back to block 1004, in event that the controller 112 determines that the CDRL deliverable is not associated with any milestone, then the method 1000 may proceed to block 1016, where the controller 112 may determine whether the CDRL deliverable is associated with a recurrence. The actions that the controller 112 performs at block 1016 to determine whether the CDRL deliverable is associated with a recurrence may be the same as those performed at block 1006, and as such are not repeated here.

At block 1016, if the controller 112 determines that the CDRL deliverable is associated with a recurrence, then the method 1000 may proceed to block 1018. At block 1018, the controller 112 may determine the delivery date for the CDRLL deliverable based on the CDRL deliverable not being associated with a milestone and being associated with a recurrence. As previously described with respect to FIG. 5, in event that a CDRL recurrence is not associated with a set of milestones, then the delivery date calculation rule associated with the CDRL recurrence may include a start date, an end date, and a day-of-month for recurrence. Correspondingly, at block 1018, the controller 112 may determine which temporal position in the CDRL deliverable is in the recurrence, such as first, second, third, and so forth. In some implementations, the controller 112 may be configured to derive the position according to the CDRL deliverable ID. That is, the CDRL deliverable ID may indicate the position, although other ways may be possible. The controller 112 may then determine the delivery date for the CDRL deliverable based on the position, the start date, and the day-of-month for recurrence information.

To illustrate, suppose a given CDRL recurrence includes a set of CDRL deliverables to be delivered on the 15th of every month, starting from Mar. 15, 2025 and extending to Mar. 15, 2035. Consistent with block 1018, the given CDRL recurrence is not associated with any milestones. In turn, suppose that the controller 112 determines that a given CDRL deliverable of the CDRL recurrence is the third CDRL deliverable to be delivered. Using the position of three, the start date of Mar. 15, 2025, and the day-of-month for recurrence day of 15, the controller 112 may determine that the delivery date for the given CDRL deliverable is May 15, 2025.

As previously described, the controller 112 may consider the delivery date determined at block 1018 as a preliminary delivery date. The method 1000 may then proceed to block 1010, where the controller 112 determines an adjusted delivery date based on whether the preliminary delivery date determined at block 1018 falls on a weekend or holiday. Then, at block 1012, the controller 112 sets the adjusted delivery date as the final delivery date for the CDRL deliverable.

Referring back to block 1016, in event that the controller 112 determines that the CDRL deliverable is not associated with a recurrence, then the method 1000 may proceed to block 1020. At block 1020, the controller 112 may determine the delivery date for the CDRL deliverable based on the CDRL deliverable not being associated with a milestone and not being associated with a recurrence. In this situation, the controller 112 may determine the delivery date to be the date that a user entered for the delivery date, such as in the add CDRL deliverable interface 400 of FIG. 4, as previously described. Also, as previously described, the controller 112 may consider the delivery date determined at block 1020 as a preliminary delivery date. The method 1000 may then proceed to block 1010, where the controller 112 determines an adjusted delivery date based on whether the preliminary delivery date determined at block 1020 falls on a weekend or holiday. Then, at block 1012, the controller 112 sets the adjusted delivery date as the final delivery date for the CDRL deliverable.

Additionally, as shown in FIG. 10, after the controller 112 sets the adjusted delivery date as the final delivery date, the method 1000 may proceed back to block 1002, where the controller 112 determines whether there are any further CDRL deliverables for which to determine a delivery date. If not, then the method 1000 may end. If so, the method 1000 may proceed to block 1004, and the method may repeat as previously described.

The method 1000 in FIG. 10 is merely an example, and other methods configured to determine delivery dates for CDRL deliverables according to whether the CDRLs are associated with a milestone and whether they are associated with a recurrence are possible. For example, at block 1004, the controller 112 may determine whether a CDRL deliverable is associated with a recurrence. Then, at block 1006 or at block 1008, the controller 112 may determine whether the CDRL deliverable is associated with a milestone. That is, the controller 112 may determine both whether a given CDRL deliverable is associated with milestone and whether it is associated with a recurrence, irrespective of any order of the determinations. In any of various implementations, the controller 112 may make the determinations in parallel or in an interleaved manner, as opposed to sequentially, such as in accordance with parallel or other types of computer processing technology.

Accordingly, in the example methods 900 and 1000, the controller 112 is configured to identify which of four possible CDRL candidate types to which the CDRL deliverable belongs, and then determine a delivery date for the CDRL deliverable according to the CDRL deliverable type to which the CDRL deliverable belongs. The four CDRL deliverable types include: 1) not associated with a milestone and not associated with a CDRL recurrence; 2) not associated with a milestone and associated with a CDRL recurrence; 3) associated with a milestone and not associated with a CDRL recurrence; and 4) associated with a milestone and associated with a CDRL recurrence. The particular CDRL deliverable type to which the CDRL deliverable belongs may dictate or determine how the controller 112 determines or calculates the delivery date, as previously described.

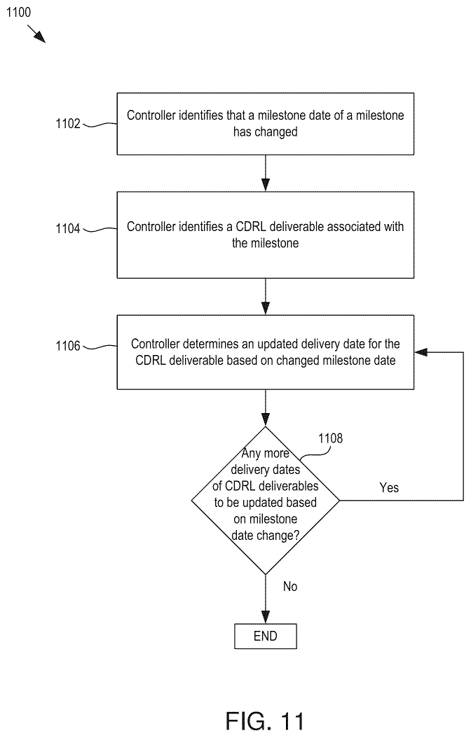

FIG. 11 shows a flow chart of another example method 1100 of CDRL deliverable management. At block 1102, the controller 112 may determine or identify that a milestone date of a milestone has changed. For example, a user may have access to the milestone database 114 to update, revise, or change an existing milestone date from one value to a second value. Although not shown, the user may be able to make the change through the CDRL management interface 110, although other ways of providing a user access to the milestone database 114 may be possible. Additionally, the change to the milestone date may trigger the controller 112 to detect or identify the change.

At block 1104, the controller 112 may identify a CDRL deliverable associated with the milestone having its milestone date changed. For example, the controller 112 may determine the milestone ID of the milestone. In turn, the controller 112 may analyze the CDRL deliverable data 104 to determine one or more CDRL deliverables associated with the milestone ID. As explained, a given CDRL deliverable may be associated with the milestone ID if that milestone ID is populated in the milestone ID field 210 of the database entry 202 for the given CDRL deliverable.

At block 1106, the controller 112 may determine an updated delivery date for the CDRL deliverable identified at block 1104 according to the changed milestone date. The updated delivery date may be determined according to the delivery date determination or calculation processes previously described, such as with respect to blocks 1006 and/or 1008 of FIG. 10. At block 1108, the controller 112 may determine whether there are any more CDRL deliverables for which to determine an updated delivery date based on the change to the milestone date. As mentioned, when a milestone date change has occurred, the controller 112 may be configured to identify all of the CDRL deliverables associated with that milestone, since their database entries are populated with the milestone ID of the milestone effected with a date change. The controller 112 may be configured to keep and update a record of which of the associated CDRL deliverables have had their delivery dates changed, and which have not, and continue to iterate through blocks 1106 and 1108 until all of the associated CDRL deliverables have had their associated delivery dates updated. In this way, only a single user input (i.e., the user input to the milestone database 114 to change the milestone date) may effect correct changes or updates to associated delivery dates for multiple, such as tens, hundreds, or even thousands of CDRL deliverables.

The present description includes additional methods in addition to the example methods 900, 1000, and 1100, including those that combine one or more of the blocks of the methods 900, 1000, and 1100 with each other. In addition or alternatively, other methods may include any of the actions described above in connection accessing, reading, and/or populating any of the fields 204-234 of the database entries 202 as previously described with respect to FIG. 2, and/or in connection with displaying and inputting the various CDRL deliverable information and corresponding visuals in the CDRL management interface 110, as previously described with reference to FIGS. 3-8, in connection with the components of the system of FIG. 1.

The above-described embodiments provide computer-implemented solutions to the complex problem of managing CDRL deliverables and ensuring that they are delivered timely. The problem is complex at least in part due to the large number of pending CDRL deliverables (i.e., CDRL deliverables that are to be delivered by a certain delivery date but have not yet been delivered) at any given point in time, and the dynamic nature of CDRL deliverables. For example, at any given point in time, there may be tens, hundreds, or even thousands of pending CDRL deliverables under a single program. Moreover, the overall composition of the CDRL deliverables is constantly changing. On a continual basis, some CDRL deliverables are completed while other CDRL deliverables are newly added to the system 100. Adding to the complexity is the conditional nature upon which CDRL deliverables are established. For example, some CDRLs are not established or placed into effect until or unless some event occurs, such as an event associated with other CDRL deliverables or an event associated with a milestone. Further adding to the complexity is that the delivery dates for CDRLs are based on a variety of sets of different criteria. Different CDRL deliverables associated with different milestones have delivery dates determined from different delivery date calculation rules. For example, one CDRL deliverable associated with one milestone may be due 30 days before one milestone date, and another CDRL deliverable associated with another milestone may be due 45 days after another milestone date. Still, in other situations, CDRL deliverables associated with the same milestone may have different delivery dates associated with different delivery date calculation rules. In addition or alternatively, some CDRL deliverables are part of recurrences, while others are not. Different recurrences may have different delivery date calculation rules. Some recurrences are associated with a set of milestones, while others are not. Compounding the complexity is that CDRL deliverable information is changing. For example, changes to milestone dates are common and may occur at random times or are not foreseeable. One milestone date change may cause delivery date changes to hundreds of CDRL deliverables having several different criteria for which their delivery dates are determined. Moreover, the customer, who often sets the criteria for the delivery dates, does not in most cases expressly provide the delivery dates to the contractor. Rather, that burden of managing all of the delivery dates is with the contractor. Tracking these delivery dates manually or in a way where the user has to determine delivery dates for CDRL deliverables on an individual basis, even with computer aided tools, is tedious, laborious, and time intensive.

The computer-implemented embodiments described herein provide a streamlined and efficient solution that minimizes the amount of user inputs into the system in order for the system to calculate delivery dates accurately and efficiently for the CDRL deliverables. For example, the embodiments described herein configures the controller 112 to identify a type, from among four different possible types, for a given CDRL, and then to determine the delivery date according to the determined type. As mentioned, the four different types include: 1) not associated with a milestone and not associated with a recurrence; 2) not associated with a milestone and associated with a recurrence; 3) associated with a milestone and not associated with a recurrence; and 4) associated with a milestone and associated with a recurrence. Configuring the controller 112 to determine or select a type for the CDRL deliverables may optimize the way the controller 112 selects the data to use to calculate associated delivery dates for all of the different CDRL deliverables and different criteria for which their delivery dates are determined.

Another way that the computer-implemented embodiments described herein provide a streamlined and efficient solution is that new CDRL deliverables are automatically shown and displayed in the CDRL management interface 110. For example, when a new CDRL deliverable is added using the new CDRL deliverable interface 400 and/or when a new CDRL recurrence is added using the new CDRL recurrence interface 500, the new CDRL data is automatically used to update the CDRL deliverable list 302 in FIG. 3 and/or the program views such as shown in FIGS. 6 and 7. No other user inputs other than those to used directly affect the desired views in the CDRL management interface 110 are needed.

Another way that the computer-implemented embodiments described herein provide a streamlined and efficient solution is that the CDRL deliverable list 302 of FIG. 3 and near term program view in FIG. 6 effect electronic visuals on a computer display that optimizes a program manager's ability to assess workflow distribution and upcoming CDRL deliverable deadlines. For example, given the extremely large amount of CDRL deliverables that are pending at any given point in time and their dynamic nature, it is extremely difficult if not impossible to optimally assess and manage the CDRL deliverables. The program view, such as the near term view, compartmentalizes the CDRL deliverables into buckets, essentially, by visually grouping them into separate areas organized by month, and displaying information about the CDRL deliverables, such as their delivery statuses or evaluations. The cumulative view of FIG. 7 provides another electronic visual that allows a program manager to visually compartmentalize the different delivery statuses, evaluations, and categories of the CDRL deliverables by cumulatively organizing them into separate curves. The CDRL management interface 110 provides an easy and quick way for a user to toggle between the different views displayed within the CDRL management interface 110.

Another way that the computer-implemented embodiments described herein provide a streamlined and efficient solution is that changes to CDRL information, such as milestone dates are automatically obtained by the system to correspondingly update delivery dates of CDRL deliverables that are tied to the changed milestone dates. For example, the system 100 generates unique milestone IDs for each of the milestones in the system 100, and then links the milestone ID to each CDRL deliverable having a delivery date that is determined from a milestone date associated with the milestone ID. The system 100 does so by including the milestone ID as part of sets of values in a database entries 202 particularly for the CDRL deliverables that are associated with the milestone. Accordingly, when a milestone date is updated, the controller 112 automatically identifies all of the delivery dates affected by the milestone date update, and in turn can update all of the affected delivery dates. Moreover, because the controller 112 is configured to calculate delivery dates in one of four ways based on the four different types of CDRL deliverables it identifies, two of which pertain to the CDRL deliverable being connected to a milestone, the controller 112 is able to efficiently update the delivery dates since it already has programmed the algorithms it uses to calculate delivery dates for CDRL deliverables connected to milestones.

Another way that the computer-implemented embodiments described herein provide a streamlined and efficient solution is that it organizes the creation of CDRL deliverables between those that are and are not associated with a recurrence. For example, as shown in FIGS. 3-5, there are two separate ways to create CDRL deliverables based on whether they are associated with recurrences or not. FIG. 3 shows two different UI elements 318 and 320, which in turn activate two different interfaces 400 and 500 in FIGS. 4 and 5, respectively. The interfaces 400, 500 themselves provide a focused collection of input boxes that enable a user to efficiently enter in information to create a single CDRL deliverable (FIG. 4), or a set of multiple CDRL deliverables associated with a recurrence (FIG. 5). The different interfaces 400, 500 for the different types of CDRL deliverables, depending on whether or not they are associated with a recurrence, provides the user with an interface 500 specifically optimized for recurrences, which in turn provides the system 100 with an ability to create several CDRL deliverables, such as on the order of hundreds, and automatically determine their respective delivery dates, in response to a single submission of a CDRL recurrence. Other tools that do not provide an interface specifically for creation and addition of CDRL recurrences may not be able to create such CDRL recurrences and their associated CDRL deliverables as quickly or as efficiently.

The techniques described above, can be implemented as computer software using computer-readable instructions and physically stored in one or more computer-readable media. For example, FIG. 12 shows a computer system 1200 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 12 for computer system 1200 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 1200.

Computer system 1200 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1201, mouse 1202, trackpad 1203, touch screen 1210, data-glove (not shown), joystick 1205, microphone 1206, scanner 1207, or camera 1208.

Computer system 1200 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1210, data-glove (not shown), or joystick 1205, but there can also be tactile feedback devices that do not serve as input devices), audio output devices (such as: speakers 1209, headphones (not depicted)), visual output devices (such as screens 1210 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1200 can also include human accessible storage devices and their associated media such as optical media including CD/DVD ROM/RW 1220 with CD/DVD or the like media 1221, thumb-drive 1222, removable hard drive or solid state drive 1223, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1200 can also include an interface 1254 to one or more communication networks 1255. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth. Certain networks commonly require external network interface adapters that attached to certain general-purpose data ports or peripheral buses 1249 (such as, for example USB ports of the computer system 1200); others are commonly integrated into the core of the computer system 1200 by attachment to a system bus as described below (for example Ethernet interface into a PC computer system or cellular network interface into a smartphone computer system). Using any of these networks, computer system 1200 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1240 of the computer system 1200.

The core 1240 can include one or more Central Processing Units (CPU) 1241, Graphics Processing Units (GPU) 1242, specialized programmable processing units in the form of Field Programmable Gate Areas (FPGA) 1243, hardware accelerators 1244 for certain tasks, graphics adapters 1250, and so forth. These devices, along with Read-only memory (ROM) 1245, Random-access memory 1246, internal mass storage such as internal non-user accessible hard drives, SSDs, and the like 1247, may be connected through a system bus 1248. In some computer systems, the system bus 1248 can be accessible in the form of one or more physical plugs to enable extensions by additional CPUs, GPU, and the like. The peripheral devices can be attached either directly to the core's system bus 1248, or through a peripheral bus 1249. In an example, the screen (1210) can be connected to the graphics adapter 1250. Architectures for a peripheral bus include PCI, USB, and the like.

CPUs 1241, GPUs 1242, FPGAs 1243, and accelerators 1244 can execute certain instructions that, in combination, can make up the aforementioned computer code. That computer code can be stored in ROM 1245 or RAM 1246. Transitional data can also be stored in RAM 1246, whereas permanent data can be stored for example, in the internal mass storage 1247. Fast storage and retrieve to any of the memory devices can be enabled through the use of cache memory, that can be closely associated with one or more CPU 1241, GPU 1242, mass storage 1247, ROM 1245, RAM 1246, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As a non-limiting example, the computer system having architecture 1200, and specifically the core 1240 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1240 that are of non-transitory nature, such as core-internal mass storage 1247 or ROM 1245. The software implementing various embodiments of the present disclosure can be stored in such devices and executed by core 1240. A computer-readable medium can include one or more memory devices or chips, according to particular needs. The software can cause the core 1240 and specifically the processors therein (including CPU, GPU, FPGA, and the like) to execute particular processes or particular parts of particular processes described herein, including defining data structures stored in RAM 1246 and modifying such data structures according to the processes defined by the software. In addition, or as an alternative, the computer system can provide functionality as a result of logic hardwired or otherwise embodied in a circuit (for example: accelerator 1244, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect includes a method that includes: identifying, with a controller, a contract data requirements list (CDRL) deliverable associated with a program; determining, with the controller, whether the CDRL deliverable is associated with a milestone of a plurality of milestones associated with the program and whether the CDRL is associated with a recurrence; determining, with the controller, a delivery date for the CDRL deliverable based on whether the CDRL is associated with the milestone and whether the CDRL deliverable is associated with the recurrence; and displaying, with the controller via a display, a CDRL deliverable name of the CDRL deliverable and at least one of: the delivery date, a delivery status corresponding to the delivery date, and a delivery evaluation corresponding to the delivery date.

A second aspect includes the first aspect and further includes in response to determining that the CDRL deliverable is not associated with any milestone of the plurality of milestones and is not associated with any recurrence of the one or more recurrences, determining the delivery date for the CDRL deliverable comprises determining the delivery date to be an input delivery date.

A third aspect includes any of the first or second aspects, and further includes in response to determining that the CDRL deliverable is not associated with any milestone of the plurality of milestones and is associated with the recurrence, determining the delivery date for the CDRL deliverable comprises determining the delivery date according to a start date and a day-of-month for recurrence value.

A fourth aspect includes any of the first through third aspects, and further includes in response to determining that the CDRL deliverable is associated with the milestone and is not associated with any recurrence, determining the delivery date for the CDRL deliverable comprises determining the delivery date according to a milestone date of the milestone and a date calculation rule associated with the CDRL deliverable.

A fifth aspect includes any of the first through fourth aspects, and further includes wherein the CDRL deliverable comprises a first CDRL deliverable, the milestone comprises a first milestone, and the delivery date comprises a first delivery date, and in response to determining that the first CDRL deliverable is associated with the first milestone of the plurality of milestones and is associated with the recurrence, determining the first delivery date for the first CDRL comprises determining the first delivery date according to a first milestone date associated with the first milestone and a date calculation rule associated with the recurrence; and determining a second delivery date for a second CDRL deliverable associated with the recurrence according to a second milestone date associated with a second milestone and the date calculation rule associated with the recurrence.

A sixth aspect includes any of the first through fifth aspects, and further includes detecting, with the controller, an update to a milestone date of the milestone; and in response to detecting the update, determining, with the controller, that the CDRL deliverable is associated with the milestone; and in response to determining that the CDRL deliverable is associated with the milestone, updating, with the controller, the delivery date for the CDRL deliverable according to the update to the milestone date.

A seventh aspect includes the sixth aspect, and further includes in response to detecting the update to the milestone date, identifying, with the controller, a set of CDRL deliverables associated with the milestone in a CDRL database by identifying which of a plurality of CDRL deliverables in the CDRL database are associated with a milestone ID of the milestone; and updating, with the controller, delivery dates for all of the CDRL deliverables associated with the milestone according to the change to the milestone date.

An eighth aspect includes any of the first through seventh aspects, and further includes querying, with the controller, a milestone database with a milestone identification (ID) of the milestone, the milestone database associating at least one milestone ID with at least one milestone date; and in response to the querying, determining, with the controller, a milestone date associated with the milestone ID, wherein determining the delivery date comprises determining the delivery date according to the milestone date.

A ninth aspect includes any of the first through eighth aspects, and further includes: displaying, with the controller via a user interface, a CDRL deliverable list indicating a plurality of CDRL deliverable names and at least one of: a plurality of delivery dates each associated with a respective one of the plurality of CDRL deliverables, a plurality of delivery statuses each associated with the respective one of the plurality of CDRLs, and a plurality of delivery evaluations each associated with the respective one of the plurality of CDRL deliverables.

A tenth aspect includes the ninth aspect, and further includes wherein the CDRL deliverable list further indicates one or more CDRL group identifications (IDs) with which each of the plurality of CDRL deliverables is associated.

An eleventh aspect includes any of the ninth or tenth aspects, and further includes wherein the CDRL deliverable list further indicates one or more owners with which each of the plurality of CDRL deliverables is associated.

A twelfth aspect includes any of the ninth through eleventh aspects, and further includes displaying, with the controller via the user interface, at least one add CDRL user interface (UI) element adjacent to the CDRL deliverable list, the at least one add CDRL UI element, upon being triggered, configured to cause display of at least one add CDRL interface for addition of a new CDRL deliverable or a new CDRL recurrence to the CDRL deliverable list.

A thirteenth aspect includes the twelfth aspect, and further includes wherein the at least one add CDRL UI element comprises an add CDRL deliverable UI element and an add CDRL recurrence UI element, and wherein the at least one add CDRL interface comprises an add CDRL deliverable interface and an add CDRL recurrence interface, and wherein the method further comprises: displaying the add CDRL deliverable interface in response to triggering the add CDRL deliverable UI element; and displaying the add CDRL recurrence interface in response to triggering the add CDRL recurrence UI element.

A fourteenth aspect includes any of the twelfth or thirteenth aspects, and further includes automatically updating, with the controller, the CDRL deliverable list with the new CDRL deliverable or the new CDRL recurrence in response to submission of information corresponding to the new CDRL deliverable or the new CDRL recurrence using the at least one add CDRL interface.

A fifteenth aspect includes of the twelfth through fourteenth aspects, and further includes wherein the at least one add CDRL interface comprises a checkbox to link the new CDRL deliverable or the new CDRL recurrence to the milestone.

A sixteenth aspect includes any of the first through fifteenth aspects, and further includes accessing, with the controller, a CDRL database comprising a database entry for the CDRL deliverable, wherein the database entry comprises CDRL deliverable identification (ID) field, a milestone ID field, and a recurrence ID field.

A seventeenth aspect includes the sixteenth aspect, and further includes wherein the database entry further comprises at least one of a deliverable content link field and a comments field.

An eighteenth aspect includes any of the first through seventeenth aspects, and further includes displaying, with the controller via a user interface, a near term view comprising a plurality of areas each associated with a respective one of a plurality of date ranges; and displaying, with the controller via the user interface, a plurality of CDRL deliverable names of a plurality of CDRL deliverables and a plurality of associated delivery statuses or a plurality of delivery evaluations in the plurality of areas according to respective delivery dates of the plurality of CDRL deliverables and the plurality of date ranges of the plurality of areas.

A nineteenth aspect includes the eighteenth aspect, and further includes displaying, with the controller via the user interface, a cumulative view comprising a plurality of curves, each curve comprising a cumulative number of CDRL deliverables as a function of time, wherein the plurality of curves is associated with at least two of: a submitted delivery status, a rework category, a questions category; a completed delivery status; a behind delivery evaluation; or an on track delivery evaluation.

A twentieth aspect includes the nineteenth aspect, and further includes switching, with the controller via the interface, between the near term view and the cumulative view in response to an input to a program view input box displayed in the user interface.

In addition to the features mentioned in each of the independent aspects enumerated above, some examples may show, alone or in combination, the optional features mentioned in the dependent aspects and/or as disclosed in the description above and shown in the figures.

What is claimed is:

1. A method comprising:
identifying, with a controller, a contract data requirements list (CDRL) deliverable associated with a program;
determining, with the controller, whether the CDRL deliverable is associated with a milestone of a plurality of milestones associated with the program and whether the CDRL is associated with a recurrence;
determining, with the controller, a delivery date for the CDRL deliverable based on whether the CDRL is associated with the milestone and whether the CDRL deliverable is associated with the recurrence; and
displaying, with the controller via a display, a CDRL deliverable name of the CDRL deliverable and at least one of: the delivery date, a delivery status corresponding to the delivery date, and a delivery evaluation corresponding to the delivery date.

2. The method of claim 1, further comprising:
in response to determining that the CDRL deliverable is not associated with any milestone of the plurality of milestones and is not associated with any recurrence of the one or more recurrences, determining the delivery date for the CDRL deliverable comprises determining the delivery date to be an input delivery date.

3. The method of claim 1, further comprising:
in response to determining that the CDRL deliverable is not associated with any milestone of the plurality of milestones and is associated with the recurrence, determining the delivery date for the CDRL deliverable comprises determining the delivery date according to a start date and a day-of-month for recurrence value.

4. The method of claim 1, further comprising:
in response to determining that the CDRL deliverable is associated with the milestone and is not associated with any recurrence, determining the delivery date for the CDRL deliverable comprises determining the delivery date according to a milestone date of the milestone and a date calculation rule associated with the CDRL deliverable.

5. The method of claim 1, wherein the CDRL deliverable comprises a first CDRL deliverable, the milestone comprises a first milestone, and the delivery date comprises a first delivery date, the method further comprising:
in response to determining that the first CDRL deliverable is associated with the first milestone of the plurality of milestones and is associated with the recurrence, determining the first delivery date for the first CDRL comprises determining the first delivery date according to a first milestone date associated with the first milestone and a date calculation rule associated with the recurrence; and
determining a second delivery date for a second CDRL deliverable associated with the recurrence according to a second milestone date associated with a second milestone and the date calculation rule associated with the recurrence.

6. The method of claim 1, further comprising:
detecting, with the controller, an update to a milestone date of the milestone;
in response to detecting the update, determining, with the controller, that the CDRL deliverable is associated with the milestone; and
in response to determining that the CDRL deliverable is associated with the milestone, updating, with the controller, the delivery date for the CDRL deliverable according to the update to the milestone date.

7. The method of claim 6, further comprising:
in response to detecting the update to the milestone date, identifying, with the controller, a set of CDRL deliverables associated with the milestone in a CDRL database by identifying which of a plurality of CDRL deliverables in the CDRL database are associated with a milestone ID of the milestone; and
updating, with the controller, delivery dates for all of the CDRL deliverables associated with the milestone according to the change to the milestone date.

8. The method of claim 1, further comprising:
querying, with the controller, a milestone database with a milestone identification (ID) of the milestone, the milestone database associating at least one milestone ID with at least one milestone date; and
in response to the querying, determining, with the controller, a milestone date associated with the milestone ID,
wherein determining the delivery date comprises determining the delivery date according to the milestone date.

9. The method of claim 1, further comprising:
displaying, with the controller via a user interface, a CDRL deliverable list indicating a plurality of CDRL deliverable names and at least one of: a plurality of delivery dates each associated with a respective one of the plurality of CDRL deliverables, a plurality of delivery statuses each associated with the respective one of the plurality of CDRLs, and a plurality of delivery evaluations each associated with the respective one of the plurality of CDRL deliverables.

10. The method of claim 9, wherein the CDRL deliverable list further indicates one or more CDRL group identifications (IDs) with which each of the plurality of CDRL deliverables is associated.

11. The method of claim 9, wherein the CDRL deliverable list further indicates one or more owners with which each of the plurality of CDRL deliverables is associated.

12. The method of claim 9, further comprising:
displaying, with the controller via the user interface, at least one add CDRL user interface (UI) element adjacent to the CDRL deliverable list, the at least one add CDRL UI element, upon being triggered, configured to cause display of at least one add CDRL interface for addition of a new CDRL deliverable or a new CDRL recurrence to the CDRL deliverable list.

13. The method of claim 12, wherein the at least one add CDRL UI element comprises an add CDRL deliverable UI element and an add CDRL recurrence UI element, and wherein the at least one add CDRL interface comprises an add CDRL deliverable interface and an add CDRL recurrence interface, and wherein the method further comprises:
displaying the add CDRL deliverable interface in response to triggering the add CDRL deliverable UI element; and
displaying the add CDRL recurrence interface in response to triggering the add CDRL recurrence UI element.

14. The method of claim 12, further comprising:
automatically updating, with the controller, the CDRL deliverable list with the new CDRL deliverable or the new CDRL recurrence in response to submission of information corresponding to the new CDRL deliverable or the new CDRL recurrence using the at least one add CDRL interface.

15. The method of claim 12, wherein the at least one add CDRL interface comprises a checkbox to link the new CDRL deliverable or the new CDRL recurrence to the milestone.

16. The method of claim 1, further comprising:
accessing, with the controller, a CDRL database comprising a database entry for the CDRL deliverable, wherein the database entry comprises CDRL deliverable identification (ID) field, a milestone ID field, and a recurrence ID field.

17. The method of claim 16, wherein the database entry further comprises at least one of a deliverable content link field and a comments field.

18. The method of claim 1, further comprising:
displaying, with the controller via a user interface, a near term view comprising a plurality of areas each associated with a respective one of a plurality of date ranges; and
displaying, with the controller via the user interface, a plurality of CDRL deliverable names of a plurality of CDRL deliverables and a plurality of associated delivery statuses or a plurality of delivery evaluations in the plurality of areas according to respective delivery dates of the plurality of CDRL deliverables and the plurality of date ranges of the plurality of areas.

19. The method of claim 18, further comprising:
displaying, with the controller via the user interface, a cumulative view comprising a plurality of curves, each curve comprising a cumulative number of CDRL deliverables as a function of time, wherein the plurality of curves is associated with at least two of: a submitted delivery status, a rework category, a questions category; a completed delivery status; a behind delivery evaluation; or an on track delivery evaluation.

20. The method of claim 19, further comprising:
switching, with the controller via the interface, between the near term view and the cumulative view in response to an input to a program view input box displayed in the user interface.
